(19) United States
(12) Patent Application Publication
(10) Pub. No.: US 2026/0323304 A1
(43) Pub. Date: Oct. 15, 2026

(54) MULTIPLE NON-PRIMARY CHANNEL ACCESS OPERATION

(71) Applicant: Ofinno, LLC, Reston, VA (US)

(72) Inventors: Jeongki Kim, Fairfax, VA (US); Leonardo Alisasis Lanante, Reston, VA (US); Esmael Hejazi Dinan, McLean, VA (US); Serhat Erkucuk, Reston, VA (US); Tuncer Baykas, Reston, VA (US); Jiayi Zhang, Rockville, MD (US)

(73) Assignee: Ofinno, LLC, Reston, VA (US)

(21) Appl. No.: 19/695,065

(22) Filed: Jun. 2, 2026

Related U.S. Application Data
(63) Continuation of application No. PCT/US2024/057692, filed on Nov. 27, 2024.
(60) Provisional application No. 63/605,622, filed on Dec. 4, 2023.

(51) Int. Cl. H04W 16/02; H04W 72/12; H04W 88/08

(52) U.S. Cl. CPC H04W 16/02; H04W 72/12; H04W 88/08

(57) ABSTRACT

An access point (AP) receives via a first channel a first frame comprising a first duration field indicating a first duration. After receiving the first frame, the AP transmits: via a second channel, a second frame comprising a second duration field indicating a second duration within the first duration; and via a third channel, a third frame comprising a third duration field indicating a third duration based on the second duration. The second channel and the third channel may be primary channels auxiliary to the first channel.

### CROSS-REFERENCE TO RELATED APPLICATIONS

This application is a continuation of International Application No. PCT/US2024/057692, filed Nov. 27, 2024, which claims the benefit of U.S. Provisional Application No. 63/605,622, filed Dec. 4, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example trigger frame.

FIG. 5 illustrates an example multi-user request to send (MU-RTS) trigger frame.

FIG. 6 illustrates an example common info field.

FIG. 7 illustrates an example of a Request-to-Send (RTS)/Clear-to-Send (CTS) procedure.

FIG. 8 illustrates an example of a wideband RTS/CTS procedure.

FIG. 9 illustrates an example of a wideband RTS/CTS procedure that uses a bandwidth signaling RTS frame.

FIG. 10 is an example that illustrates an MU-RTS/CTS procedure.

FIG. 11 is an example that illustrates existing multiple primary channel (MPC) STA operation.

FIG. 12 illustrates virtual and physical carrier sense (CS) functions associated with primary and secondary channels for an MPC STA and a non-MPC STA.

FIG. 13 is an example that contrasts the operation of a concurrent CCA MPC STA and the operation of a non-concurrent CCA MPC STA.

FIG. 14 is another example that contrasts the operation of a concurrent CCA MPC STA and the operation of a non-concurrent CCA MPC STA.

FIG. 15 illustrates an example of subchannel selection transmission (SST) operation.

FIG. 16 illustrates an example problem that may arise in SST operation.

FIG. 17 illustrates an example of an SST-based operation according to an embodiment.

FIG. 18 illustrates an example of another SST-based operation according to an embodiment.

FIG. 19 illustrates an example of another SST-based operation according to an embodiment.

FIG. 20 illustrates an example operation that may arise according to existing network allocation vector (NAV) reset rules.

FIG. 21 illustrates an example of another SST-based operation according to an embodiment.

FIG. 22 illustrates an example of another SST-based operation according to an embodiment.

FIG. 23 illustrates an example of another SST-based operation according to an embodiment.

FIG. 24 illustrates an example process according to an embodiment.

FIG. 25 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

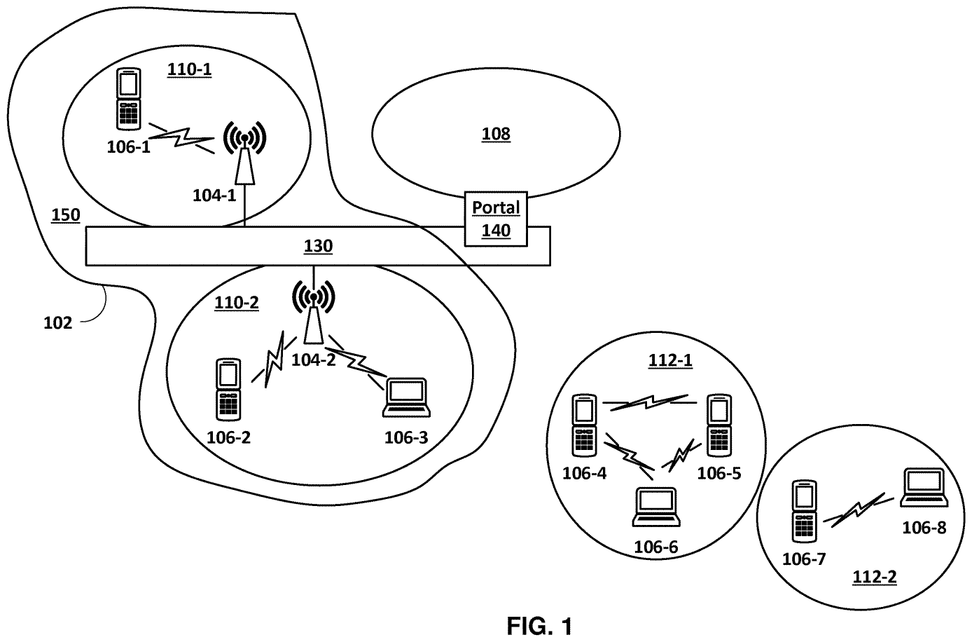

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be optionally formed through channel bonding of a primary 20 MHz channel and one or more 20 MHz secondary channels. For example, PPDUs may be transmitted over physical channels having bandwidths of 40 MHz, 80 MHz, 160 MHz, or 320 MHz by bonding together a primary 20 MHz channel and 1, 3, 7, or 15 secondary channel respectively. The primary channel is a common channel operation for all STAs where management frames are sent by the AP to ensure that all STAs (regardless of channel bonding support) can receive.

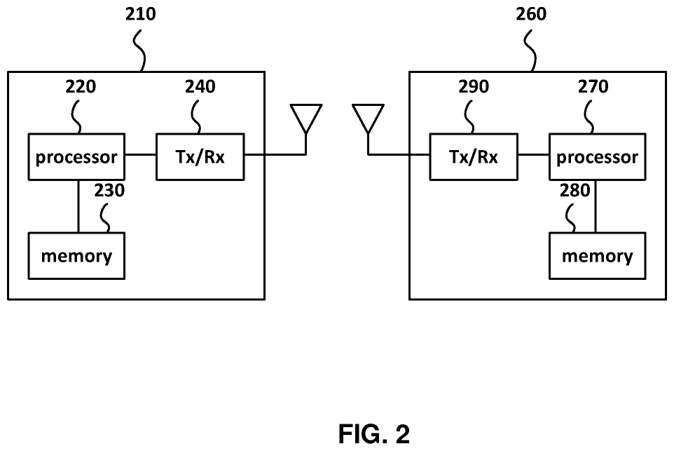

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

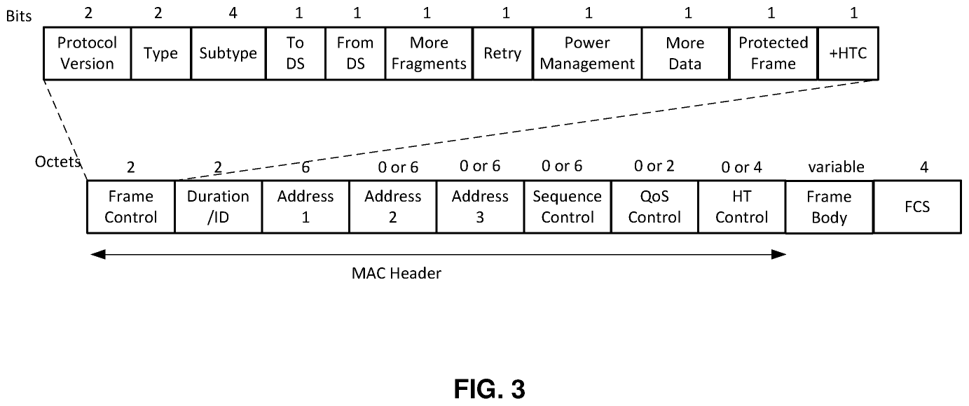

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

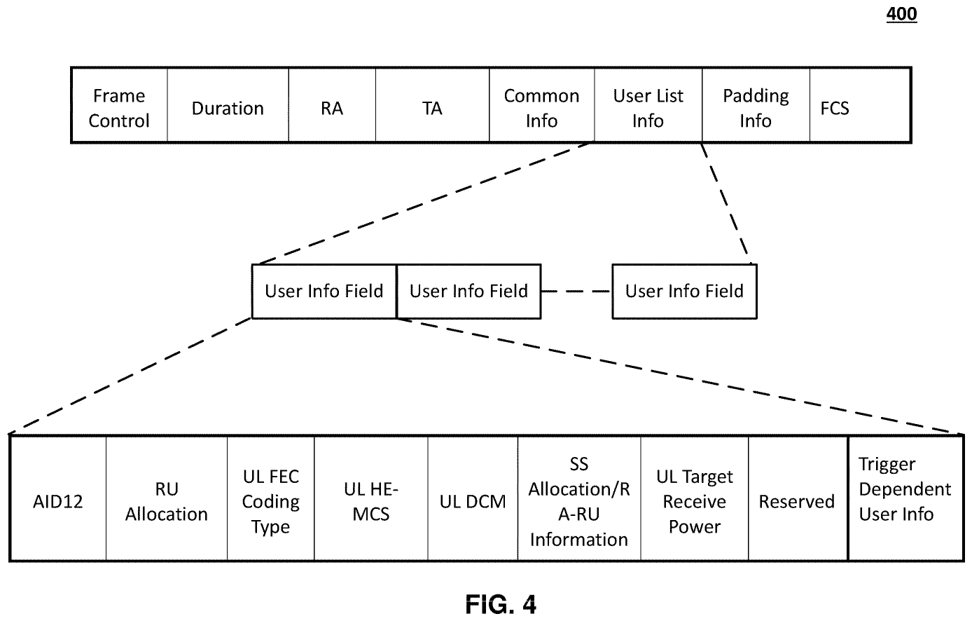

FIG. 4 illustrates an example trigger frame 400. Trigger frame 400 may correspond to a basic trigger frame as defined in the existing IEEE 802.11ax standard amendment. Trigger frame 400 may be used by an AP to allocate resources for and solicit one or more TB PPDU transmissions from one or more STAs. Trigger frame 400 may also carry other information required by a responding STA to transmit a TB PPDU to the AP.

As shown in FIG. 4, trigger frame 400 includes a Frame Control field, a Duration field, a receiver address (RA) field, a transmitter address (TA) field, a Common Info field, a User List Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 400 if trigger frame 400 is addressed to STAs that belong to a single BSS. The TA field is the transmitted BSSID if the trigger frame 400 is addressed to STAs from at least two different BSSs of the multiple BSSID set.

The common info field may have a format as illustrated by common info field 600 described further below. The common info field specifies a trigger frame type of trigger frame 400, a transmit power of trigger frame 400 in dBm, and several key parameters of a TB PPDU that is transmitted by a STA in response to trigger frame 400. The trigger frame type of a trigger frame used by an AP to receive QoS data using UL MU operation is referred to as a basic trigger frame.

The User List Info field contains a User Info field per STA addressed in trigger frame 400. The per STA User Info field includes, among others, an AID subfield, an RU Allocation subfield, a Spatial Stream (SS) Allocation subfield, an MCS subfield to be used by a STA in a TB PPDU transmitted in response to trigger frame 400, and a Trigger Dependent User Info subfield. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 400 to extend the frame length to give recipient STAs enough time to prepare a response for transmission one SIFS (short interframe spacing) after the frame is received. The Padding field, if present, is at least two octets in length and is set to all 1s.

The FCS field is used by a STA to validate a received frame and to interpret certain fields from the MAC headers of a frame.

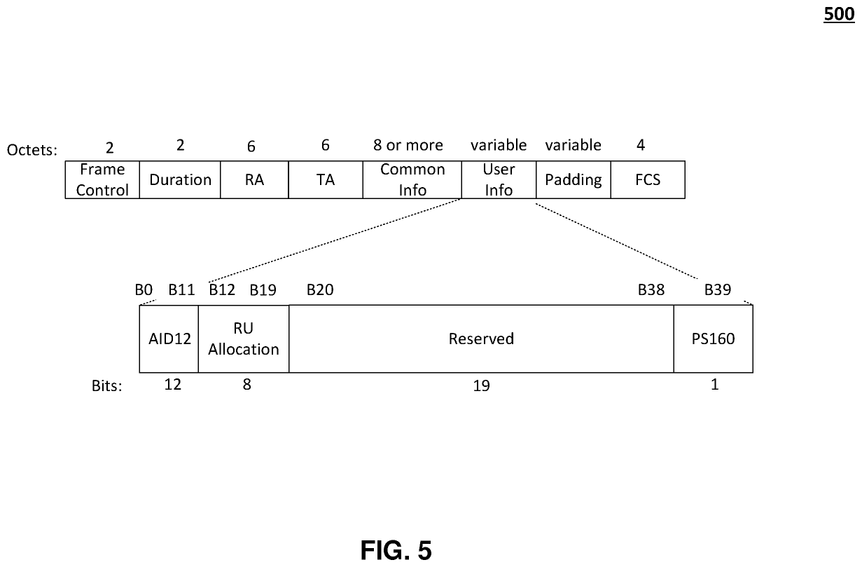

FIG. 5 illustrates an example multi-user request to send (MU-RTS) trigger frame 500. MU-RTS trigger frame 500 may be used by an AP to solicit simultaneous CTS frames from multiple STAs to transmit a downlink (DL) MU PPDU to the multiple STAs. As shown in FIG. 5, MU-RTS trigger frame 500 may comprise a frame control field, a duration field, an RA field, a TA field, a common info field, one or more user info fields, a padding field, and an FCS field. The frame control, TA, RA, padding, and FCS fields may be similar to the corresponding fields of trigger frame 400 described above. The common info field may have a format as illustrated by common info field 600 described further below. The duration field may be set to the time, in microseconds, required to transmit the DL MU PPDU, plus the time required to transmit one CTS frame, one ACK frame (if required), and three SIFS periods.

The one or more user info fields correspond respectively to the one or more STAs solicited by MU-RTS trigger frame 500. As shown in FIG. 5, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160MHz, an 80+80 Mhz channel, or a 320 MHz channel.

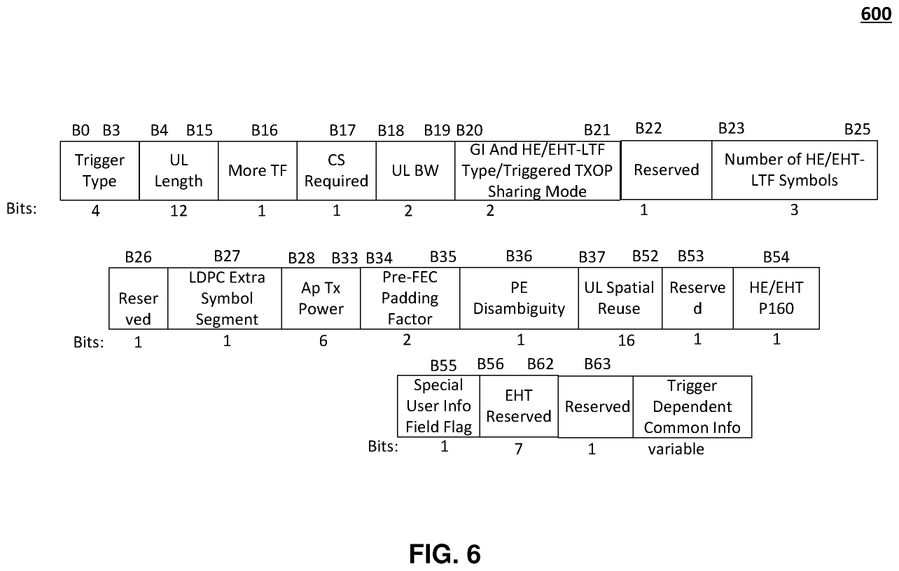

FIG. 6 illustrates an example Common Info field 600. Common Info field 600 may be an embodiment of the Common Info field of trigger frame 400 or MU-RTS trigger frame 500, for example. As shown in FIG. 6, Common Info field 600 may include a Trigger Type subfield, a UL Length subfield, a More TF subfield, a CS required subfield, a UL BW subfield, a GI and HE/EHT-LTF Type/Triggered TXS Mode subfield, a first Reserved subfield, a Number of HE/EHT-LTF Symbols subfield, a second Reserved subfield, an LDPC Extra Symbol Segment subfield, an AP Tx Power subfield, a Pre-FEC Padding Factor subfield, a PE Disambiguity subfield, an UL Spatial Reuse subfield, a third Reserved subfield, an HE/EHT P160 subfield, a Special User Info Field Flag subfield, an EHT Reserved subfield, a fourth Reserved subfield, and a Trigger Dependent Common Info subfield. The Trigger Type subfield, UL Length subfield, More TF subfield, CS required subfield, UL BW subfield, GI and HE-LTF Type/Triggered TXS Mode subfield, first Reserved subfield, Number of HE/EHT-LTF Symbols subfield, second Reserved subfield, LDPC Extra Symbol Segment subfield, AP Tx Power subfield, Pre-FEC Padding Factor subfield, PE Disambiguity subfield, UL Spatial Reuse subfield, third Reserved subfield, HE/EHT P160 subfield, Special User Info Field Flag subfield, EHT Reserved subfield, fourth Reserved subfield, and Trigger Dependent Common Info subfield may have the same content and interpretation as corresponding subfields of an EHT variant Common Info field defined in the IEEE 802.11be draft amendment (“IEEE P 802.11be/D3.1, March 2023”).

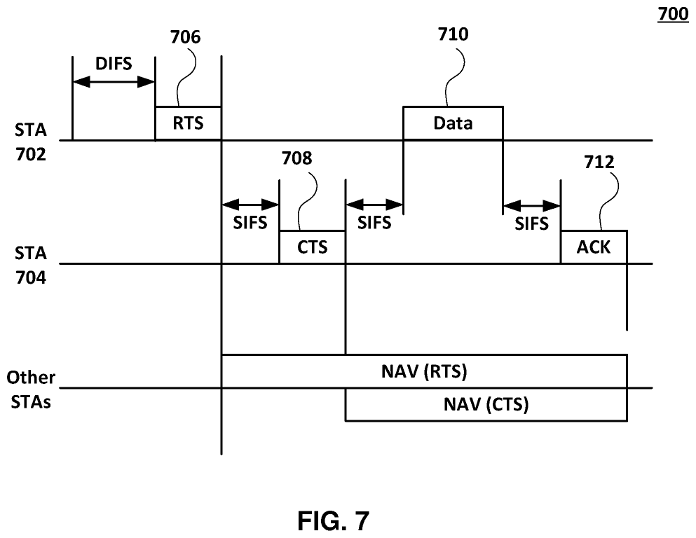

FIG. 7 illustrates an example 700 of a Request-to-Send (RTS)/Clear-to-Send (CTS) procedure. Example 700 may be an example according to the RTS/CTS procedure as defined in section 10.3.2.9 of the IEEE 802.11 standard draft “IEEE P 802.11-REVme™/D3.0, April 2023.” As shown in FIG. 7, example 700 may include STAs 702 and 704. Other STAs of the same BSS may also be within communication range of STAs 702 and 704.

In an example, STA 702 may transmit an RTS frame 706 to STA 704. STA 702 may transmit RTS frame 706 to protect from hidden STA(s) the transmission of a data frame 710 that STA 702 intends to transmit. RTS frame 706 may include a Duration/ID field. The Duration/ID field may be set to the time, in microseconds, required to transmit data frame 710, plus one CTS frame, plus one ACK frame (if required), plus three SIFS (Short Interframe Spacing) periods.

In an example, STA 704 may respond to RTS frame 706 by transmitting a CTS frame 708 to STA 702. CTS frame 708 may be transmitted one SIFS period after RTS frame 706. STA 704 may respond to RTS frame 706 when RTS frame 706 is addressed to STA 704 and after considering the NAV, unless the NAV was set by a frame originating from STA 702. STA 704 may respond to the RTS frame 706 when RTS frame 706 is addressed to STA 704 and if the NAV indicates idle. For a non-S1G STA, the NAV indicates idle when the NAV count is 0 or when the NAV count is non-zero but a nonbandwidth signaling TA obtained from a TA field of RTS frame 706 matches a saved TXOP holder address. For an S1G STA, the NAV indicates idle when both the NAV and RID (response indication deferral) counters are 0 or when either the NAV or RID counter is non-zero but the TA field of RTS frame 706 matches the saved TXOP holder address.

STA 704 may set an RA field of CTS frame 708 to a nonbandwidth signaling TA obtained from the TA field of RTS frame 706. STA 704 may set a Duration field of CTS frame 708 based on the Duration/ID field of RTS frame 706, namely as equal to the value of the Duration/ID field of RTS frame 706, adjusted by subtracting the time required to transmit CTS frame 708 and one SIFS period.

Upon receiving CTS frame 708, STA 702 may wait one SIFS period before transmitting data frame 710. STA 704 may transmit an ACK frame 712 in response to data frame 710. STA 704 may transmit ACK frame 712 one SIFS after receiving data frame 710.

As shown in example 700, other STAs within communication range of STAs 702 and 704, and belonging to the same BSS, may set their NAVs according to RTS frame 706 and/or CTS frame 708. For example, a STA receiving RTS frame 706 may set its NAV based on the Duration/ID field of RTS frame 706. Another STA receiving CTS frame 708 may set its NAV based on the Duration field of CTS frame 708. As such, the other STAs may not access the channel using Enhanced Distributed Channel Access (EDCA) until the end of transmission of ACK frame 712.

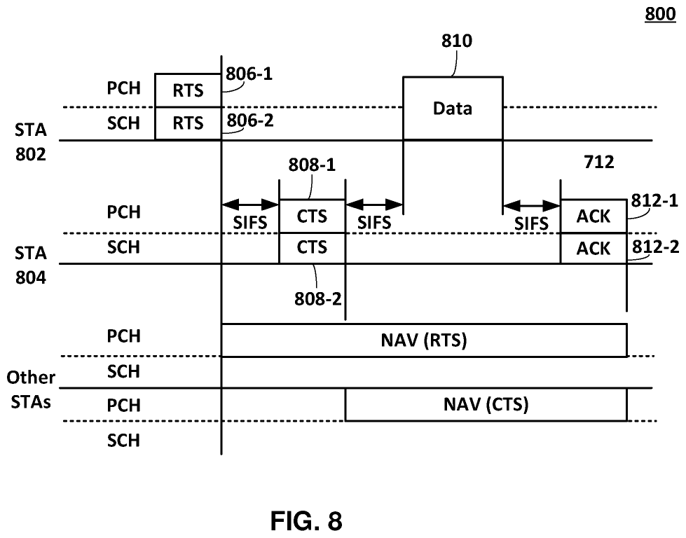

FIG. 8 illustrates an example 800 of a wideband RTS/CTS procedure. As shown in FIG. 8, example 800 may include STAs 802 and 804. Other STAs may also be within communication range of STAs 802 and 804. STAs 802 and 804 may each operate on a primary channel (PCH) and a secondary channel (SCH). For example, without limitation, the PCH may correspond to a primary 20 MHz channel and the SCH may correspond to a secondary 20 MHz channel.

Example 800 may begin with STA 802 accessing both the PCH and SCH to transmit simultaneously RTS frames 806-1 and 806-2 on the PCH and the SCH, respectively, to STA 804. In an example, RTS frames 806-1 and 806-2 may be transmitted in a non-HT (non-High Throughput) duplicate PPDU having a bandwidth equal to the combined bandwidth of the PCH and the SCH (e.g., 40 MHz). In an implementation, before transmitting RTS frames 806-1 and 806-2, STA 802 may check a NAV associated with the PCH. If the NAV associated with the PCH indicates that the PCH is idle, STA 802 may perform a clear channel assessment (CCA) on the PCH and the SCH. The CCA may include determining whether a received signal energy on a channel exceeds an energy detect (ED) threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 802 may access both the PCH and the SCH to transmit RTS frames 806-1 and 806-2.

RTS frames 806-1 and 806-2 may be duplicate frames. RTS frames 806-1 and 806-2 may include a duration field indicating the time, in microseconds, required to transmit a data frame 810, plus one CTS frame, plus one Ack frame, plus three SIFSs.

On receiving RTS frames 806-1 and 806-2, other STAs within the communication range of STA 802 may set a NAV associated with the PCH based on RTS frame 806-1. In an implementation, the other STAs may not maintain a NAV for the SCH.

On receiving RTS frames 806-1 and 806-2, STA 804 responds to STA 802 by transmitting CTS frames 808-1 and 808-2 on the PCH and the SCH respectively. CTS frames 808-1 and 808-2 may be transmitted a SIFS after STA 804 receives RTS frames 806-1 and 806-2 respectively. In an implementation, STA 804 transmits CTS frames 808-1 and 808-2 on the PCH and the SCH respectively based on a NAV associated with the PCH indicating that the PCH is idle. In an implementation, STA 804 may not maintain a NAV for the SCH or may not check a NAV associated with the SCH before transmitting CTS frames 808-1 and 808-2.

On receiving CTS frames 808-1 and 808-2, other STAs within the communication range of STA 804 may set a NAV associated with the PCH based on CTS frame 808-1. In an implementation, the other STAs may not maintain a NAV for the SCH.

On receiving CTS frames 808-1 and 808-2, STA 802 may proceed to transmit data frame 810 on both the PCH and the SCH. Data frame 810 may be transmitted a SIFS after STA 802 receives CTS frames 808-1 and 808-2. In an implementation, STA 802 may proceed to transmit data frame 810 on both the PCH and the SCH on the sole condition of receiving CTS frame 808-1 on the PCH. That is, STA 802 may not be required to receive CTS frame 808-2 on the SCH to transmit data frame 810 on the SCH as well as the PCH.

In an implementation, STA 804 may acknowledge data frame 810 by transmitting ACK frames 812-1 and 812-2 on the PCH and the SCH, respectively. ACK frames 812-1 and 812-2 may be transmitted a SIFS after STA 804 receives data frame 810.

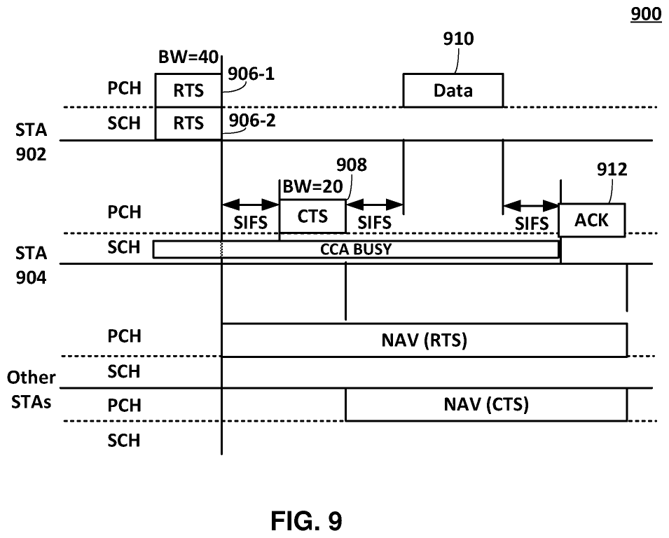

FIG. 9 illustrates an example 900 of a wideband RTS/CTS procedure that uses a bandwidth signaling RTS frame. As shown in FIG. 9, example 900 may include STAs 902 and 904. Other STAs may also be within communication range of STAs 902 and 904. STAs 902 and 904 may each operate on a primary channel (PCH) and a secondary channel (SCH). For example, without limitation, the PCH may correspond to a primary 20 MHz channel and the SCH may correspond to a secondary 20 MHz channel.

Example 900 may begin with STA 902 accessing both the PCH and SCH to transmit simultaneously RTS frames 906-1 and 906-2 on the PCH and the SCH, respectively, to STA 904. In an example, RTS frames 906-1 and 906-2 may be transmitted in a non-HT duplicate PPDU having a bandwidth equal to the combined bandwidth of the PCH and the SCH (e.g., 40 MHz). In an implementation, before transmitting RTS frames 906-1 and 906-2, STA 902 may check a NAV associated with the PCH. If the NAV associated with the PCH indicates that the PCH is idle, STA 902 may perform a CCA on the PCH and the SCH. The CCA may include determining whether a received signal energy on a channel exceeds an ED threshold. The CCA returns a “channel busy” condition when the received signal energy on the channel exceeds the ED threshold and a “channel idle” condition when the received signal energy on the channel is below the ED threshold. If the CCA indicates “channel idle” on both the PCH and the SCH, STA 902 may access both the PCH and the SCH to transmit RTS frames 906-1 and 906-2.

RTS frames 906-1 and 906-2 may be duplicate frames. RTS frames 906-1 and 906-2 may include a duration field indicating the time, in microseconds, required to transmit a data frame 910, plus one CTS frame, plus one Ack frame, plus three SIFSs.

In example 900, RTS frames 906-1 and 906-2 may be bandwidth signaling RTS frames. That is, RTS frames 906-1 and 906-2 may each include a field that indicates the bandwidth of the PPDU (e.g., 40 MHz) carrying RTS frames 906-1 and 906-2.

On receiving RTS frames 906-1 and 906-2, other STAs within the communication range of STA 902 may set a NAV associated with the PCH based on RTS frame 906-1. In an implementation, the other STAs may not maintain a NAV for the SCH.

On receiving RTS frames 906-1 and 906-2, STA 904 may decode the field indicating the bandwidth of the PPDU carrying RTS frames 906-1 and 906-2. The PPDU bandwidth may indicate to STA 904 that STA 902 wishes that STA 904 respond with CTS frames on both the PCH and the SCH. In an implementation, before responding to RTS frames 906-1 and 906-2, STA 904 may check a NAV associated with the PCH. In an implementation, STA 904 may not maintain a NAV for the SCH or may not check a NAV associated with the SCH before responding to RTS frames 906-1 and 906-2. In an implementation, if the NAV associated with the PCH indicates that the PCH is idle, STA 904 may perform a CCA on the PCH and the SCH. In an implementation, STA 904 may respond on both the PCH and the SCH if the CCA indicates “channel idle” on both the PCH and the SCH. In an implementation, STA 904 may respond on the PCH only if the CCA indicates “channel idle” on the PCH and “channel busy” on the SCH. In an implementation, STA 904 may not respond on the PCH or the SCH if the NAV associated with the PCH is non-zero.

In example 900, the CCA returns “channel idle” on the PCH and “channel busy” on the SCH. As such, STA 904 may transmit a CTS frame 908 only on the PCH. CTS frame 908 may thus have a bandwidth that is narrower than the PPDU bandwidth indicated in RTS frames 906-1 and 906-2. CTS frame 908 may be transmitted a SIFS after STA 904 receives RTS frames 906-1 and 906-2 respectively.

On receiving CTS frame 908, other STAs within the communication range of STA 904 may set a NAV associated with the PCH based on CTS frame 908.

On receiving CTS frame 908, STA 902 may proceed to transmit data frame 910 on the PCH. Data frame 910 may be transmitted a SIFS after STA 902 receives CTS frame 908. In an implementation, STA 904 may acknowledge data frame 910 by transmitting an ACK frame 912 on the PCH. ACK frame 912 may be transmitted a SIFS after STA 904 receives data frame 910.

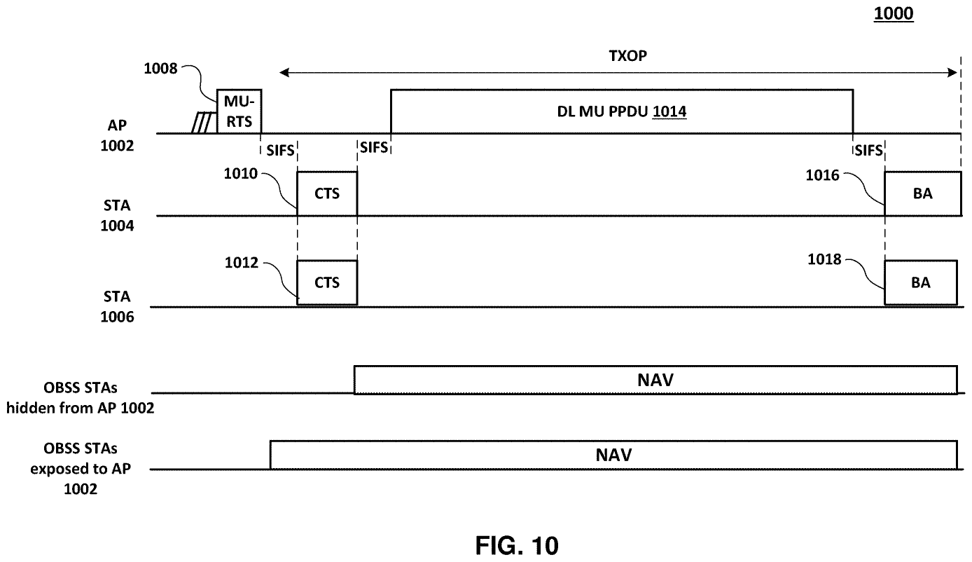

FIG. 10 is an example 1000 that illustrates a multi-user Request-to-Send (MU-RTS)/Clear-to-Send (CTS) procedure. Example 1000 may be an example according to the MU-RTS/CTS procedure as defined in section 26.2.6 of the IEEE 802.11 standard draft (“IEEE P 802.11-REVme™/D3.0, April 2023”). As shown in FIG. 10, example 1000 may include an AP 1002 and STAs 1004 and 1006. STAs 1004 and 1006 may be associated with AP 1002. For the purpose of illustration, example 1000 also illustrates STAs of an overlapping basic service set (OBSS) relative to the BSS of AP 1002 (OBSS STAs). The OBSS STAs, as shown in FIG. 10, may be hidden from AP 1002 (outside of the communication range of AP 1002) or exposed to AP 1002 (within the communication range of AP 1002).

In example 1000, AP 1002 wishes to transmit a downlink (DL) multi-user (MU) PPDU 1014 to STAs 1004 and 1006. DL MU PPDU 1014 may comprise data for each of STAs 1004 and 1006. DL MU PPDU 1014 may occupy a plurality of channels (e.g., 20 MHz channels). Each channel of the plurality of channels may carry the data for a respective STA (e.g., STA 1004, STA 1006) served by DL MU PPDU 1014.

As shown in FIG. 10, to protect the transmission of DL MU PPDU 1014 to STAs 1004 and 1006 from interference by OBSS STAs hidden from AP 1002, AP 1002 may use the MU-RTS/CTS procedure to initiate a TXOP and to protect the TXOP frame exchange sequence. AP 1002 may initiate the TXOP by transmitting an MU-RTS trigger frame 1008 that solicits simultaneous CTS frame transmissions from STAs 1004 and 1006.

MU-RTS trigger frame 1008 may have a format as illustrated by MU-RTS trigger frame 500 illustrated in FIG. 5. As such, MU-RTS trigger frame 1008 may comprise a frame control field, a duration field, an RA field, a TA field, a common info field, one or more user info fields, a padding field, and an FCS field. The duration field may be set to the time, in microseconds, required to transmit DL MU PPDU 1014, plus the time required to transmit one CTS frame, one ACK frame (if required), and three SIFS periods.

The one or more user info fields correspond respectively to the one or more STAs solicited by the MU-RTS trigger frame. In example 1000, MU-RTS trigger frame 1008 may comprise a user info field for each of STAs 1004 and 1006 indicating that a CTS frame is solicited from each of STAs 1004 and 1006. As shown in FIG. 8, a user info field may comprise an AID12 subfield, an RU allocation subfield, reserved bits, and a PS 160 subfield. The AID12 subfield comprises an association identifier of the STA to which the user info field is addressed. The RU allocation subfield indicates a channel on which the solicited STA is to transmit the CTS frame. In an example, this may include a primary 20 MHz channel, a primary 40 MHz, a primary 80 MHz channel, a primary 160 MHz, an 80+80 Mhz channel, or a 320 MHz channel.

AP 1002 may send MU-RTS trigger frame 1008 in a PPDU that occupies one or more channels (e.g., 20 MHz channels). In an example, for each channel occupied by the PPDU that carries MU-RTS trigger frame 1008, AP 1002 may request at least one non-AP STA to send a CTS frame that occupies that channel. In an example, AP 1002 may not request that a non-AP STA send a CTS frame that occupies a channel that is not occupied by the PPDU carrying MU-RTS trigger frame 1008.

After transmitting MU-RTS trigger frame 1008, AP 1002 may wait for a CTSTimeout interval of aSIFSTime+aSlotTime+aRxPHYStartDelay that begins when a MAC layer of AP 1002 receives a PHYTXEND.confirm primitive for transmitted MU-RTS trigger frame 1008. If the MAC layer does not receive a PHY-RXEARLYSIG.indication or a PHY-RXSTART.indication primitive during the CTSTimeout interval, AP 1002 may conclude that the transmission of MU-RTS trigger frame 1008 has failed, and, if MU-RTS trigger frame 1008 initiated a TXOP, AP 1002 may invoke its backoff procedure. If the MAC layer receives a PHY-RXEARLYSIG.indication or a PHY-RXSTART.indication primitive during the CTSTimeout interval, then the MAC layer may wait for the corresponding PHY-RXEND.indication primitive to determine whether transmission of MU-RTS trigger frame 1008 was successful. The receipt of a CTS frame from any non-AP STA addressed by MU-RTS trigger frame 1008 before the PHY-RXEND.indication primitive shall be interpreted as the successful transmission of MU-RTS trigger frame 1008, permitting the frame exchange sequence to continue. The receipt of any other type of frame shall be interpreted as a failure of the transmission of MU-RTS trigger frame 1008. AP 1002 may process the received frame and, if MU-RTS trigger frame 1008 initiated a TXOP, AP 1002 shall invoke its backoff procedure at the PHY-RXEND.indication primitive.

In example 1000, on receiving MU-RTS trigger frame 1008, STAs 1004 and 1006 respond by transmitting respectively CTS frames 1010 and 1012 to AP 1002. In an example, STAs 1004 and 1006 begin the transmission of CTS frames 1010 and 1012, respectively, at the SIFS time boundary after an end of a received PPDU comprising MU-RTS trigger frame 1008. In an example, STA 1004 (or STA 1006) responds to MU-RTS trigger frame 1008 with a CTS frame when the following conditions are met: MU-RTS trigger frame 1008 comprises a user info field addressed to the STA (the AID12 subfield of the user info field is equal to the 12 LSBs of the AID of the STA) and MU-RTS trigger frame 1008 is sent by an AP with which the STA is associated; and the UL MU CS condition indicates that the medium is idle as described in section 26.5.2.5 (UL MU CS mechanism) of the IEEE 802.11 standard (“IEEE P802.11-REVme™/D3.0, April 2023”). Otherwise, if one of the conditions is not met, STA 1004 (or STA 1006) does not send a CTS frame to AP 1002.

In an example, STAs 1004 and 1006 may set an RA field of respectively CTS frames 1010 and 1012 to a TA obtained from the TA field of MU-RTS trigger frame 1008. In an example, STAs 1004 and 1006 may set a duration field of respectively CTS frames 1010 and 1012 based on the duration field of MU-RTS trigger frame 1008, namely as equal to the value of the duration field of MU-RTS trigger frame 1008, adjusted by subtracting the time required to transmit respectively CTS frames 1010 and 1012 and one SIFS period.

OBSS STAs exposed to AP 1002 may receive MU-RTS trigger frame 1008 due to being within the communication range of AP 1002. In an example, as shown in FIG. 10, on receiving MU-RTS trigger frame 1008, OBSS STAs exposed to AP 1002 set their respective NAVs based on the duration field of MU-RTS trigger frame 1008. As such, the OBSS STAs exposed to AP 1002 may not access the wireless medium for the duration of the TXOP initiated by AP 1002.

OBSS STAs hidden from AP 1002 do not receive MU-RTS trigger frame 1008 due to being outside the communication range of AP 1002. However, in an example, as shown in FIG. 10, some of the OBSS STAs hidden from AP 1002 may receive CTS frame 1010 and/or CTS frame 1012 and may set their respective NAVs based on the duration field of CTS frame 1010 and/or CTS frame 1012. As such, some of the OBSS STAs hidden from AP 1002 may also not access the wireless medium for the duration of the TXOP initiated by AP 1002.

On receiving CTS frame 1010 and/or CTS frame 1012, AP 1002 may wait one SIFS period before transmitting DL MU PPDU 1014. On receiving DL MU PPDU 1014, STAs 1004 and 1006 may respond by transmitting respective BlockAck (BA) frames 1016 and 1018 to AP 1002.

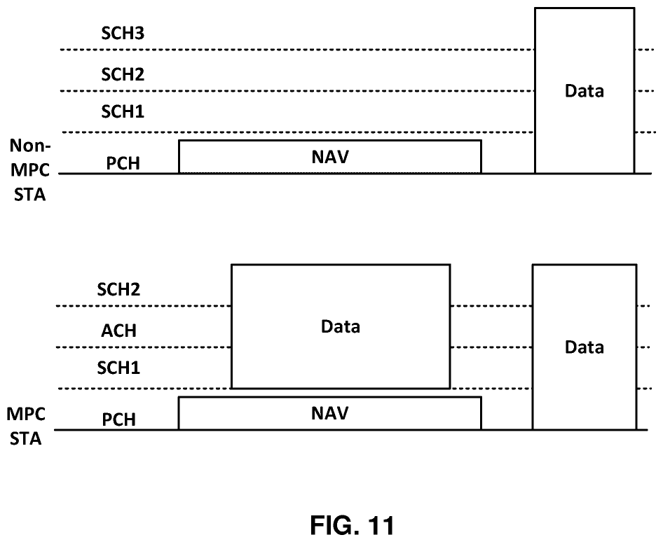

It is envisioned in future IEEE 802.11 standards that a STA may operate with multiple primary channels. Such a STA may be referred to as a multiple primary channel STA (MPC STA). Specifically, in addition to a default primary channel (which is used by all STAs in the BSS), an MPC STA may have one or more secondary channels considered as primary channels. Hereinafter, the default primary channel is referred to as “primary channel” and secondary channel(s) considered as primary channel(s) are referred to as anchor channel(s) (or auxiliary primary channel(s)). The MPC STA may transmit or receive on a channel that includes such anchor channel(s) but that does not necessarily include the primary channel (e.g., when the primary channel is unavailable). An MPC STA may maintain a NAV for an anchor channel independent of the NAV associated with the primary channel. FIG. 11 is an example 1100 that illustrates an existing MPC STA operation mode. For the purpose of illustration, MPC STA operation is contrasted with single primary channel STA (non-MPC STA) operation. As shown in FIG. 11, the non-MPC STA may be capable of operating over a plurality of channels, including a primary channel (PCH), a first secondary channel (SCH1), a second secondary channel (SCH2), and a third secondary channel (SCH2). In an example, the channel corresponding to the second secondary channel (SCH2) of the non-MPC STA may correspond to an anchor channel (ACH) of the MPC STA, and the channel corresponding to the third secondary channel (SCH3) of the non-MPC STA may correspond to a second secondary channel (SCH2) of the MPC STA. The primary channel (PCH) and the first secondary channel (SCH1) of the non-MPC STA and the MPC STA correspond to the same channels. Among these channels, the non-MPC STA supports a single primary channel (i.e., PCH), whereas the MPC STA supports two primary channels (PCH and ACH).

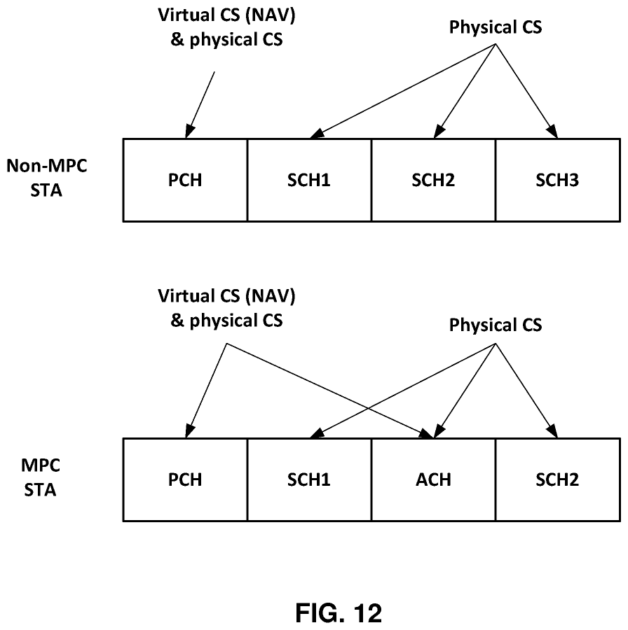

In an implementation, as shown in FIG. 12, in non-MPC STA operation, a virtual carrier sense (CS) function (e.g., NAV) may be associated with only the PCH. Secondary channels may have only a physical CS function (e.g., energy detection) associated with them, which may be performed only when contending for transmission on the PCH. As such, as shown in FIG. 11, a non-MPC STA may only transmit on a channel that includes the PCH (e.g., PCH, PCH+SCH1, PCH+SCH1+SCH2, PCH+SCH1+SCH2+SCH3) and only when the NAV associated with the PCH is zero (and the physical CS function indicates “channel idle” for all channels being used).

In contrast, as shown in FIG. 12, in MPC STA operation, a virtual CS function (e.g., NAV) may be associated with multiple channels (e.g., PCH and ACH). As such, as shown in FIG. 11, an MPC STA may transmit on channels that do not include the PCH but that include the ACH (e.g., ACH, ACH+SCH1, ACH+SCH2) if the NAV associated with the ACH is zero (and the physical CS indicates “channel idle” for all channels being used). In an implementation, an MPC STA may also transmit on channels that do not include the PCH but that include the ACH (e.g., ACH, ACH+SCH1,ACH+SCH2) if the MPC STA detects that the ACH is idle using physical CS for at least a medium synchronization duration.

In implementations, an MPC STA may perform physical and/or virtual CS functions (herein referred to as CS or CCA) on multiple channels (e.g., PCH and ACH). If the PCH is busy (non-zero NAV or CCA indicates “channel busy”), the MPC STA may use the ACH for transmission if the ACH is idle (zero NAV and CCA indicates “channel idle”).

In an implementation, an MPC STA may perform CS in parallel on multiple channels, including the PCH and the ACH. Such a STA is referred to herein as a concurrent CCA MPC STA (such a STA may also be referred to as a concurrent CCA non-primary channel access (NPCA) STA or a Type 1 STA). Because of its concurrent CCA capability, a concurrent CCA MPC STA is capable of medium synchronization simultaneously on multiple channels (e.g., PCH and ACH). Medium synchronization on a channel (e.g., PCH or ACH) may be performed by detecting a frame that includes NAV information or by listening to the channel for at least a medium synchronization duration and finding the channel idle throughout the medium synchronization duration. An MPC STA that does not support this capability may perform CS on a single channel at a time. In an implementation, an MPC STA may perform CS on the PCH by default, and when the PCH is found busy, the STA may perform CS on the ACH. Such a STA is referred to herein as a non-concurrent CCA MPC STA (such a STA may also be referred to as a non-concurrent CCA MPCA STA or a Type 2 STA). In contrast to the concurrent CCA MPC STA, a non-concurrent CCA MPC STA may only synchronize to the ACH after the PCH is found busy. Hence, it may need to listen to the channel for at least a medium synchronization duration (if it does not receive any frame that includes NAV information) before it is able to transmit.

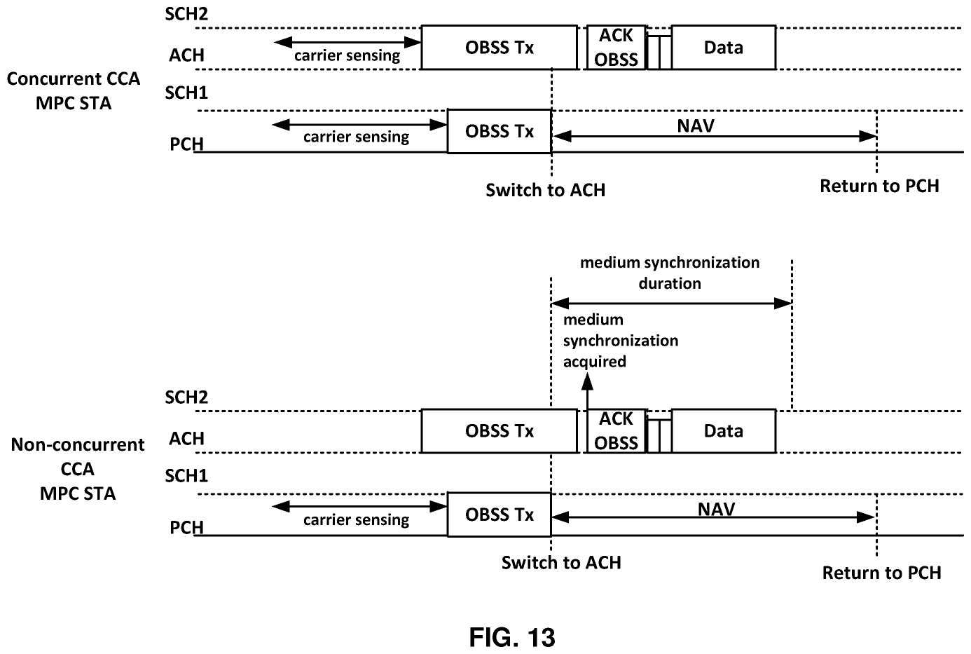

FIG. 13 is an example that contrasts the operation of a concurrent CCA MPC STA and the operation of a non-concurrent CCA MPC STA. As shown in FIG. 13, both the concurrent CCA MPC STA and the non-concurrent MPC STA may operate over a plurality of channels, including a primary channel (PCH), a first secondary channel (SCH1), an anchor channel (ACH), and a second secondary channel (SCH2). The concurrent CCA MPC STA may perform concurrent CS on the PCH and the ACH. The non-concurrent CCA MPC STA may perform CS on the PCH only.

The example of FIG. 13 may begin with the concurrent CCA MPC STA or the non-concurrent CCA MPC STA operating on the PCH. In an example, a first OBSS transmission may begin on the PCH. As both the concurrent CCA MPC STA and the non-concurrent CCA MPC STA perform CS on the PCH, both may detect the first OBSS transmission. In an implementation, on detecting the first OBSS transmission on the PCH, the concurrent CCA MPC STA and the non-concurrent CCA MPC STA may both be configured to set a NAV associated with the PCH (based on a duration of the first OBSS transmission) and to switch to the ACH for the duration of the NAV.

In an example, before or during the first OBSS transmission on the PCH, a second OBSS transmission may begin on the ACH. Having concurrent CS capability, the concurrent CCA MPC STA may detect the second OBSS transmission before switching to the ACH. In an implementation, the concurrent CCA MPC STA may set a NAV associated with the ACH based on the second OBSS transmission. The concurrent CCA MPC STA may wait until an end of the second OBSS transmission (and any associated ACK frames) before attempting to access the ACH to transmit a data frame. The concurrent CCA MPC STA may perform a random backoff before transmitting the data frame on the ACH. The concurrent CCA MPC STA may switch back to the PCH when the NAV associated with the PCH reaches zero.

In contrast, the non-concurrent CCA MPC STA may not detect the second OBSS transmission before switching to the ACH. On switching to the ACH, the non-concurrent CCA MPC STA may thus not be aware of the second OBSS transmission being transmitted on the ACH. At the same time, the non-concurrent CCA MPC STA may not have knowledge of a future time at which it may access the ACH. In an implementation, the non-concurrent MPC STA may be configured to wait for at least a medium synchronization duration for the ACH, after switching to the ACH, before attempting to access the ACH, unless a transmission is detected by the STA during the medium synchronization duration. In an implementation, the non-concurrent MPC STA may start a “MediumSyncDelay” timer for the medium synchronization duration, after switching to the ACH. In an implementation, the value of the “MediumSyncDelay” timer may be set to a “dot11MSDTimerDuration” value. The STA may initialize the “dot11MSDTimerDuration” to an “aPPDUMaxTime” value as defined in Table 36-70 (EHT PHY characteristics) of the IEEE 802.11be draft amendment (“Draft P802.11be_D4.1”). The STA may update the “dot11MSDTimerDuration” with a value contained in a Medium Synchronization Delay Information field, if present, of a Basic Multi-Link element in the most recent frame received from its associated AP. In an implementation, the non-concurrent MPC STA may reset the “MediumSyncDelay” timer to zero when the STA receives an MPDU or when the STA receives a PPDU for which the RXVECTOR parameter “TXOP_DURATION” is not set to “UNSPECIFIED.”

In the example of FIG. 13, the non-concurrent CCA MPC STA may detect and receive an ACK frame associated with the second OBSS transmission, after switching to the ACH. Reception of the ACK frame allows the non-concurrent CCA MPC STA to reset the “MediumSyncDelay” timer to zero and to acquire medium synchronization on the ACH. The non-concurrent CCA MPC STA may wait for an end of the ACK frame before performing a random backoff to transmit a data frame on the ACH. The non-concurrent CCA MPC STA may switch back to the PCH when the NAV associated with the PCH reaches zero.

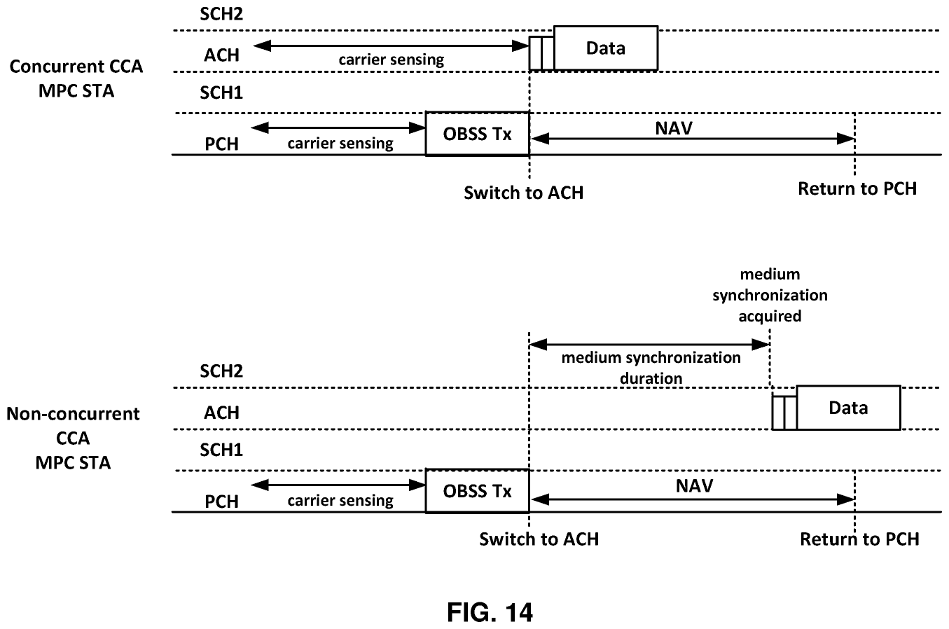

FIG. 14 is another example that contrasts the operation of a concurrent CCA MPC STA and the operation of a non-concurrent CCA MPC STA. As in the example of FIG. 13, both the concurrent CCA MPC STA and the non-concurrent MPC STA may operate over a plurality of channels, including a primary channel (PCH), a first secondary channel (SCH1), an anchor channel (ACH), and a second secondary channel (SCH2). The concurrent CCA MPC STA may perform concurrent CS on the PCH and the ACH. The non-concurrent CCA MPC STA may perform CS on the PCH only.

The example of FIG. 14 may begin with the concurrent CCA MPC STA or the non-concurrent CCA MPC STA operating on the PCH. In an example, a first OBSS transmission may begin on the PCH. As both the concurrent CCA MPC STA and the non-concurrent CCA MPC STA perform CS on the PCH, both may detect the first OBSS transmission. In an implementation, on detecting the first OBSS transmission on the PCH, the concurrent CCA MPC STA and the non-concurrent CCA MPC STA may both be configured to set a NAV associated with the PCH (based on a duration of the first OBSS transmission) and to switch to the ACH for the duration of the NAV.

In an example, the ACH may be idle at the time that the concurrent CCA MPC STA or the non-concurrent CCA MPC STA switches to the ACH. Having concurrent CS capability, the concurrent CCA MPC STA may be aware that the ACH is idle when the concurrent CCA MPC STA switches to the ACH. The concurrent CCA MPC STA may thus attempt to access the ACH immediately after switching to the ACH. As shown in FIG. 14, the concurrent CCA may perform a random backoff before transmitting a data frame on the ACH. The concurrent CCA MPC STA may switch back to the PCH when the NAV associated with the PCH reaches zero.

In contrast, on switching to the ACH, the non-concurrent CCA MPC STA may not have knowledge of whether the ACH is idle or busy. In an implementation, the non-concurrent MPC STA may be configured to wait for at least a medium synchronization duration for the ACH, after switching to the ACH, before attempting to access the ACH, unless a transmission is detected by the STA during the medium synchronization duration. In an implementation, the non-concurrent MPC STA may start a “MediumSyncDelay” timer for the medium synchronization duration, after switching to the ACH. In an implementation, the value of the “MediumSyncDelay” timer may be set to a “dot11MSDTimerDuration” value. The STA may initialize the “dot 11MSDTimerDuration” to an “aPPDUMaxTime” value as defined in Table 36-70 (EHT PHY characteristics) of the IEEE 802.11be draft amendment (“Draft P802.11be_D4.1”). The STA may update the “dot11MSDTimerDuration” with a value contained in a Medium Synchronization Delay Information field, if present, of a Basic Multi-Link element in the most recent frame received from its associated AP. In an implementation, the non-concurrent MPC STA may reset the “MediumSyncDelay” timer to zero when the STA receives an MPDU or when the STA receives a PPDU for which the RXVECTOR parameter “TXOP_DURATION” is not set to “UNSPECIFIED.”

In the example of FIG. 14, the non-concurrent CCA MPC STA may not detect or receive any frame during the medium synchronization duration. The non-concurrent CCA MPC STA may thus not reset the “MediumSyncDelay” timer to zero. The non-concurrent CCA MPC STA may only acquire medium synchronization on the ACH after the entire medium synchronization duration has elapsed. The non-concurrent CCA MPC STA may thus have to wait for the entirety of the medium synchronization duration before attempting to access the ACH. This is despite the fact that the ACH is idle and available for use during the medium synchronization duration. Buffered data at the non-concurrent CCA MPC STA may thus be delayed unnecessarily and the ACH may thus be under-utilized.

Subchannel selection transmission (SST) is a feature that was introduced in the 802.11ah standard amendment. It allows stations to rapidly select and switch to different channels between transmissions to counter fading over narrow subchannels. (Sub 1 GHz) S1G STAs that are associated with an S1G AP transmit and receive on the channel or channels that are indicated by the AP as the enabled operating channels for the BSS. An SST BSS is an S1G BSS for which the following conditions are satisfied:
a) A BSS operating channel width indicated in a Channel Width field of an S1G Operation Information element transmitted by the AP is less than or equal to 2 MHz; and
b) The SST AP of the BSS indicates that it enables SST operation by including an SST Operation element in the (Re)Association Response frame sent to a non-AP STA.

In an S1G BSS that is not an SST BSS, the enabled operating channels are indicated in the most recently received S1G Operation element transmitted by the AP. In an S1G SST BSS, the enabled operating channels are indicated in the most recently received SST Operation element transmitted by the AP.

An SST AP is an S1G AP with dot11SelectiveSubchannelTransmissionPermitted equal to true. During aperiodic SST operation, an SST AP indicates the set of enabled SST operating channels in an SST Operation element. During aperiodic SST operation, an SST AP indicates the subset of SST channels that SST STAs are allowed to access during a beacon interval or short beacon interval in an SST element that is transmitted in an S1G Beacon frame that initiates that interval and/or in a Channel Indication subfield of Restricted Access Window (RAW) parameter set (RPS) elements that include SST STAs in the RAW group. During periodic SST operation, an SST AP indicates the set of enabled SST operating channels in an SST Operation element and indicates the subset of SST channels that SST STAs are allowed to access during a beacon interval or short beacon interval in an RPS element with the Periodic RAW Indication subfield equal to 1.

An SST STA is an S1G STA that is associated with an SST AP. An SST STA chooses a subset of the operating channels enabled for SST operation on which to operate in the BSS, when SST operating channels are activated by the AP as indicated in the SST element, the SST operation element, or the RPS element. SST STAs operating in an SST BSS are allowed to transmit on an SST channel during a beacon interval or short beacon interval only if the channel is permitted for SST use as indicated by the SST AP in an SST element included in the S1G Beacon frame that initiates that interval or as indicated by an RPS element in the case of periodic SST operation.

High Efficiency (HE) SST is defined for HE AP and non-AP STAs. An HE STA that supports HE SST operation shall set dot11HESubchannelSelectiveTransmissionImplemented to true and shall set an HE Subchannel Selective Transmission Support field in the HE Capabilities element it transmits to 1. An HE STA that does not support HE SST operation shall set the HE Subchannel Selective Transmission Support field in the HE Capabilities element it transmits to 0. A non-AP HE STA with dot 11HESubchannelSelectiveTransmissionImplemented equal to true is an HE SST non-AP STA. An HE AP with dot11HESubchannelSelectiveTransmissionImplemented equal to true is an HE SST AP.

An HE SST non-AP STA and an HE SST AP may set up SST operation by negotiating a trigger-enabled Target Wake Time (TWT) as defined in section 26.8.2 (Individual TWT agreements) of the IEEE 802.11 standard with the following exceptions:
The TWT request may have a TWT Channel field with up to one bit set to 1 to indicate the secondary channel requested to contain the RU allocations addressed to the HE SST non-AP STA that is a 20 MHz operating STA. The TWT request may have a TWT Channel field with all 4 LSBs or all 4 MSBs set to 1 to indicate whether the primary 80 MHz channel or the secondary 80 MHz channel is requested to contain the RU allocations addressed to the HE SST non-AP STA that is an 80 MHz operating STA.
The TWT response shall have a TWT Channel field with up to one bit set to 1 to indicate the secondary channel that will contain the RU allocations addressed to the HE SST non-AP STA that is a 20 MHz operating STA.
The TWT response shall have a TWT Channel field with all 4 LSBs or all 4 MSBs set to 1 to indicate whether the primary 80 MHz channel or the secondary 80 MHz channel will contain the RU allocations addressed to the HE SST non-AP STA that is an 80 MHz operating STA.

An HE SST non-AP STA and an HE SST AP that successfully set up SST operation shall follow the rules below.

If an HE SST AP causes its operating channel or channel width to change and if any secondary channel of a trigger-enabled TWT is not within the new operating channel or channel width, then the HE SST AP and the HE SST non-AP STA implicitly terminate the trigger-enabled TWT.

The HE SST AP follows the rules in section 26.8.2 (Individual TWT agreements) of the IEEE 802.11 to exchange frames with the HE SST non-AP STA during trigger-enabled TWT SPs, except that the AP shall ensure the following:
The individually addressed RUs allocated in DL MU PPDUs and in Trigger frames addressed to the HE SST non-AP STA are within the subchannel indicated in the TWT Channel field of the TWT response and follow the RU restriction rules defined in section 27.3.2.8 (RU restrictions for 20 MHz operation) of the IEEE 802.11 standard if the HE SST non-AP STA is a 20 MHz operating STA and in section 27.3.2.9 (80 MHz operating non-AP HE STAs) of the IEEE 802.11 standard if the HE SST non-AP STA is an 80 MHz operating STA.
The TXVECTOR parameter CH_BANDWIDTH of a DL MU PPDU is not set to HE-CBW-PUNC160-PRI20, HE-CBW-PUNC80+80-PRI20, HE-CBW-PUNC160-SEC40, or HE-CBW-PUNC80+80-SEC40 if the DL MU PPDU is addressed to at least one HE SST non-AP STA that is an 80 MHz operating STA operating in a secondary channel.
The trigger-enabled TWT SPs do not overlap with TBTTs at which DTIM beacons are sent.
The same subchannel is used for all trigger-enabled TWT SPs with the same HE SST non-AP STA that overlap in time.

The HE SST non-AP STA follows the rules in section 26.8.2 (Individual TWT agreements) of the IEEE 802.11 standard to exchange frames with the HE SST AP during trigger-enabled TWT SPs, except that the STA:
Shall be available in the subchannel indicated in the TWT Channel field of the TWT response at TWT start times.
Shall not access the medium in the subchannel using DCF or EDCAF.
Shall not respond to Trigger frames addressed to it (see 26.5 (MU operation) and 26.8.2 (Individual TWT agreements) of the IEEE 802.11 standard) unless it has performed CCA until a frame is detected by which it can set its NAV, or until a period equal to NAVSyncDelay has transpired, whichever is earlier.
Shall update its NAV according to section 26.2.4 (Updating two NAVs) of the IEEE 802.11 standard if it receives a PPDU in the subchannel.

An HE SST non-AP STA may include a Channel Switch Timing element in (Re)Association Request frames it transmits to an HE SST AP to indicate the time required by the STA to switch between different subchannels. The received channel switch time informs the HE SST AP of the duration of time that the HE SST non-AP STA might not be available to receive frames before the TWT start time and after the end of the trigger-enabled TWT SP.

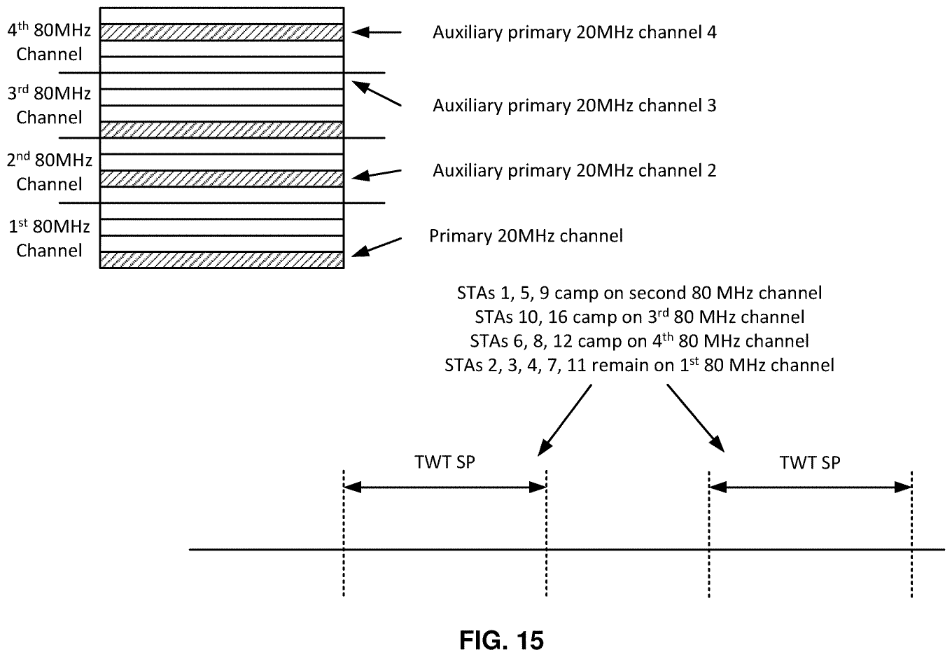

FIG. 15 illustrates an example of SST operation. For illustration, it is assumed that the SST operation takes place in a BSS that includes an AP and a plurality of STAs (STAs 1-12) associated with the AP. The AP may be an SST AP. The BSS may operate over a plurality of channels, including a primary channel and a plurality of non-primary (or auxiliary primary) channels. The primary channel may correspond to a first 80 MHz channel. The non-primary channels may correspond to second and subsequent 80 MHz channels (e.g., second 80 MHz channel, third 80 MHz channel, and fourth 80 MHz channel).

Each of the plurality of channels may include a plurality of 20 MHz channels. The primary channel may include a primary 20 MHz channel and one or more secondary 20 MHz channels. The non-primary (or auxiliary primary) channels may include an auxiliary primary 20 MHz channel and one or more secondary 20 MHz channels. For 80 MHz channels, the first 80 MHz channel may include a primary 20 MHz channel and three secondary 20 MHz channels. The non-primary channels may each include an auxiliary primary 20 MHz channel and three secondary 20 MHz channels. The auxiliary primary 20 MHz channel may or may not correspond to the first 20 MHz channel of the non-primary channel. The primary/auxiliary primary channel may correspond to a channel that a STA may access using EDCA after performing a random backoff.

In the example of FIG. 15, the non-primary channels may be enabled as SST channels. As such, SST STAs of the plurality of STAs may set up SST operation by negotiating TWT agreements with the AP as described above. This may include each SST STA negotiating with the AP an SST channel for a respective TWT SP. The SST STA may switch to the SST channel before a start time of the TWT SP and may return to the primary channel after an end time of the TWT SP. For example, in FIG. 15, STAs 1, 5, and 9 may camp on the second 80 MHz channel for their negotiated TWT SPs, STAs 10 and 16 may camp on the third 80 MHz channel for their negotiated TWT SPs, and STAs 6, 8, and 12 may camp on the fourth 80 MHz channel for their negotiated TWT SPs. STAs 2, 3, 4, 7, and 11 may however remain on the primary channel for their negotiated TWT SPs. For example, some of STAs 2, 3, 4, 7, and 11 may be STAs that do not support SST operation.

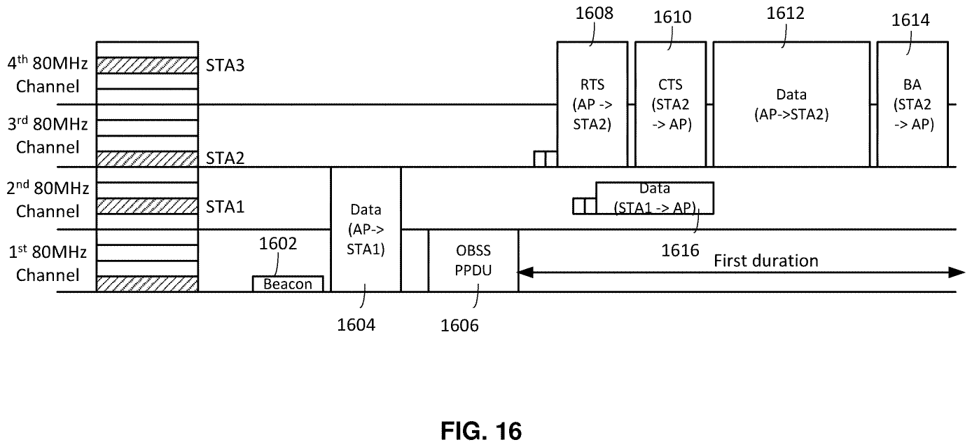

FIG. 16 illustrates an example problem that may arise in SST operation. As in FIG. 15, it is assumed in FIG. 16 that the SST operation takes place in a BSS operating over a plurality of channels, including a primary channel and a plurality of non-primary (or auxiliary primary) channels. The primary channel may correspond to a first 80 MHz channel. The non-primary channels may correspond to second and subsequent 80 MHz channels (e.g., second 80 MHz channel, third 80 MHz channel, and fourth 80 MHz channel). As described above, each of the plurality of channels may include a plurality of 20 MHz channels, including a primary/auxiliary primary 20 MHz channel and one or more secondary 20 MHz channels.

The BSS may include an AP and a plurality of STAs (e.g., STA1, STA2, and STA3) associated with the AP. The AP may be an SST AP. In an implementation, as shown in FIG. 16, the AP may be configured to transmit a beacon frame 1602 on the primary channel. In an implementation, beacon frame 1602 may be carried in 20 MHz PPDUs and may be transmitted on the primary 20 MHz channel of the primary channel. In an implementation, beacon frame 1602 may indicate in an SST element a subset of SST channels that SST STAs are allowed to access during a beacon interval or a short beacon interval initiated by beacon frame 1602.

In an implementation, as shown in FIG. 16, when the AP is operating on the primary channel, the AP may transmit a data frame 1604 to a STA (e.g., STA1) on the primary channel and at least one adjacent non-primary channel.

In the example of FIG. 16, the non-primary channels may be enabled as SST channels. In an example, as shown in FIG. 16, an OBSS (or inter-BSS) PPDU 1606 may be transmitted on the primary channel. OBSS PPDU 1606 is transmitted by an OBSS (or inter-BSS) STA or an OBSS (or inter-BSS) AP. OBSS PPDU 1606 may comprise a first duration field indicating a first duration. The first duration comprises a time period for transmission and reception of one or more frames by the OBSS STA or the OBSS AP on the primary channel after OBSS PPDU 1606. On hearing OBSS PPDU 1606, the AP, STA1, STA2, and STA3 may set a NAV for the primary channel based on the first duration. In an implementation, on hearing OBSS PPDU 1606, one or more of the plurality of STAs that are SST STAs may be configured to switch to a respective SST channel for the duration of OBSS PPDU 1606. For example, as shown in FIG. 16, STA1 may be configured to switch to the second 80 MHz channel, STA2 may be configured to switch to the third 80 MHz channel, and STA3 may be configured to switch to the fourth 80 MHz channel.

In an example, as shown in FIG. 16, the AP may obtain a TXOP on the auxiliary primary 20 MHz channel of the third 80 MHz channel and may proceed to transmit an RTS frame 1608 to STA2 camped on the third 80 MHz channel. In an example, STA2 may be a 160 MHz operating STA. The AP may thus use a non-HT duplicate PPDU transmission to transmit RTS frame 1608 to STA2 over both the third and fourth 80 MHz channels. In a non-HT duplicate PPDU transmission, a 20 MHz non-HT PPDU is duplicated over the whole bandwidth (e.g., 160 MHz in this example). STA2 may respond to RTS frame 1608 from the AP by transmitting a CTS frame 1610 to the AP. STA2 may also use a non-HT duplicate PPDU transmission to transmit CTS frame 1610 over both the third and fourth 80 MHz channels. Subsequently, the AP may transmit a data frame 1612 to STA2, and STA2 may acknowledge data frame 1612 by transmitting a BA frame 1614 to the AP. Data frame 1612 may be transmitted over both the third and fourth 80 MHz channels, e.g., in a 160 MHz PPDU. BA frame 1614 may also be transmitted using a non-HT duplicate PPDU transmission over both the third and fourth 80 MHz channels.

In an example, as shown in FIG. 16, while the AP transmits RTS frame 1608 to STA2, STA1, which is camped on the second 80 MHz channel, may obtain a TXOP on the auxiliary primary channel of the second 80 MHz channel and may begin transmitting a data frame 1616 to the AP. However, as the AP is transmitting to STA2 over the third and fourth 80 MHz channels, the AP may fail to receive data frame 1616 from STA1 over the second 80 MHz channel. For example, the AP may have a single radio frequency (RF) transceiver chain for the link comprising the first, second, third, and fourth 80 MHz and thus may not be able to transmit and receive simultaneously on different channels. This may lead to resources being wasted and to increased latency in delivering the data from STA1 to the AP.

Embodiments of the present disclosure, as further described below, address the above-described problem. In an aspect, an AP may receive, via a first channel, a first frame comprising a first duration field indicating a first duration. The first channel may be primary channel of the AP. The first frame may be received from an OBSS STA or an OBSS AP. The first duration may indicate a time period for transmission and reception of one or more frames by the OBSS STA or OBSS AP on the first channel after the first frame. After receiving the first frame, the AP may transmit, via a second channel, a second frame comprising a second duration field indicating a second duration. The second channel may comprise a non-primary channel (or an auxiliary primary channel). The second duration may indicate a time period for transmission and reception of one or more frames by the AP or a STA associated with the AP on the second channel after the second frame. The second duration may be within the first duration. Concurrently with transmitting the second frame, the AP may transmit, via a third channel, a third frame comprising a third duration field indicating a third duration based on the second duration. The third channel may comprise a non-primary channel (or an auxiliary primary channel). In an embodiment, the AP may transmit the third frame on condition of the third channel being idle at the time of transmission of the second frame on the second channel. The transmission of the third frame on the third channel may comprise transmitting the third frame on an auxiliary primary 20 MHz channel and, optionally, one or more secondary 20 MHz channels of the third channel. The transmission by the AP of the third frame on the third channel reserves the third channel for the third duration. STAs associated with the AP may thus not communicate with the AP over the third channel while the AP is communicating over the second channel. Further aspects and embodiments of the present disclosure are described further below.

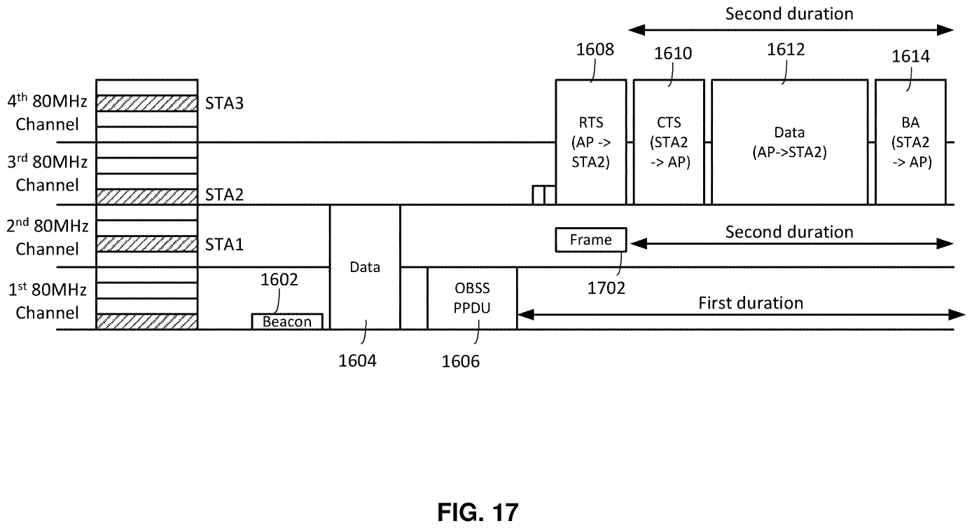

FIG. 17 illustrates an example of an SST-based operation according to an embodiment. As in FIG. 16, it is assumed in FIG. 17 that the SST operation takes place in a BSS operating over a plurality of channels, including a primary channel and a plurality of non-primary (or auxiliary primary) channels. The primary channel may correspond to a first 80 MHz channel. The non-primary channels may correspond to second and subsequent 80 MHz channels (e.g., second 80 MHz channel, third 80 MHz channel, and fourth 80 MHz channel). As described above, each of the plurality of channels may include a plurality of 20 MHz channels, including a primary/auxiliary primary 20 MHz channel and one or more secondary 20 MHz channels. The BSS may include an AP and a plurality of STAs (e.g., STA1, STA2, and STA3) associated with the AP. The AP may be an SST AP.

In an implementation, as shown in FIG. 17, the AP may be configured to transmit a beacon frame 1602 on the primary channel. In an implementation, beacon frame 1602 may be carried in 20 MHz PPDUs and may be transmitted on the primary 20 MHz channel of the primary channel. In an implementation, beacon frame 1602 may indicate in an SST element a subset of SST channels that SST STAs are allowed to access during a beacon interval or a short beacon interval initiated by beacon frame 1602.

In an implementation, as shown in FIG. 17, when the AP is operating on the primary channel, the AP may transmit a data frame 1604 to a STA (e.g., STA1) on the primary channel and at least one adjacent non-primary channel.

In the example of FIG. 17, the non-primary channels may be enabled as SST channels. In an example, as shown in FIG. 17, an OBSS (or inter-BSS) PPDU 1606 may be transmitted on the primary channel. OBSS PPDU 1606 is transmitted by an OBSS (or inter-BSS) STA or an OBSS (or inter-BSS) AP. OBSS PPDU 1606 may comprise a first duration field indicating a first duration. The first duration comprises a time period for transmission and reception of one or more frames by the OBSS STA or the OBSS AP on the primary channel after OBSS PPDU 1606. On hearing OBSS PPDU 1606, the AP, STA1, STA2, and STA3 may set a NAV for the primary channel based on the first duration. In an implementation, on hearing OBSS PPDU 1606, one or more of the plurality of STAs that are SST STAs may be configured to switch to a respective SST channel for the duration of OBSS PPDU 1606. For example, as shown in FIG. 16, STA1 may be configured to switch to the second 80 MHz channel, STA2 may be configured to switch to the third 80 MHz channel, and STA3 may be configured to switch to the fourth 80 MHz channel.

In an example, as shown in FIG. 17, the AP may obtain a TXOP on the auxiliary primary 20 MHz channel of the third 80 MHz channel and may proceed to transmit an RTS (or an MU-RTS) frame 1608 to STA2 camped on the third 80 MHz channel. RTS frame 1608 may comprise a second duration field indicating a second duration. The second duration comprises a time period for transmission and reception of one or more frames by the AP on the third 80 MHz channel. The second duration may be within the first duration. In an example, STA2 may be a 160 MHz operating STA. The AP may thus use a non-HT duplicate PPDU transmission to transmit RTS frame 1608 to STA2 over both the third and fourth 80 MHz channels. In a non-HT duplicate PPDU transmission, a 20 MHz non-HT PPDU is duplicated over whole bandwidth (e.g., 160 MHz in this example). STA2 may respond to RTS frame 1608 from the AP by transmitting a CTS frame 1610 to the AP. STA2 may also use a non-HT duplicate PPDU transmission to transmit CTS frame 1610 over both the third and fourth 80 MHz channels. Subsequently, the AP may transmit a data frame 1612 to STA2, and STA2 may acknowledge data frame 1612 by transmitting a BA frame 1614 to the AP. Data frame 1612 may be transmitted over both the third and fourth 80 MHz channels, e.g., in a 160 MHz PPDU. BA frame 1614 may also be transmitted using a non-HT duplicate PPDU transmission over both the third and fourth 80 MHz channels.

In an embodiment, in addition to transmitting RTS frame 1608 on the third 80 MHz channel (and optionally the fourth 80 MHz channel), the AP may be configured to transmit a frame 1702 on the second 80 MHz channel. Transmission of frame 1702 may be conditioned on the auxiliary primary 20 MHz channel of the second 80 MHz channel being idle. In another embodiment, the AP may configured to transmit frame 1702 on the second 80 MHz and on any other auxiliary primary channel that is idle. For example, if RTS frame 1608 is transmitted over only the third 80 MHz channel e.g., because STA2 is an 80 MHz operating STA, the fourth 80 MHz channel may be idle at the time of transmission of RTS frame 1608. The AP may thus transmit frame 1702 on the fourth 80 MHz channel in addition to the second 80 MHz channel. The AP may use a non-HT duplicate PPDU transmission to transmit frame 1702 on multiple non-primary (or auxiliary primary) channels.

Frame 1702 may be a frame that initiates a TXOP on the second 80 MHz channel. For example, frame 1702 may be an RTS frame, a CTS-to-self frame, a control frame, or a null data packet (NDP) frame. In an implementation, the AP may transmit frame 1702 on the second 80 MHz concurrently with transmitting RTS frame 1608 on the third 80 MHz channel. In another implementation, the AP may transmit frame 1702 on the second 80 MHz channel only after receiving CTS frame 1610. In an implementation, the AP may transmit frame 1702 concurrently with the transmission of data frame 1612 on the third 80 MHz channel.

As would be understood by a person of skill in the art based on the teachings herein, transmission of frame 1702 as described herein is not limited to the AP transmitting an RTS frame on the third 80 MHz channel. For example, the AP may transmit frame 1702 on the second 80 MHz channel whenever it transmits any frame on the third 80 MHz channel.

In an implementation, as shown in FIG. 17, the AP may transmit frame 1702 on only the auxiliary primary 20 MHz channel of the second 80 MHz channel (and optionally the auxiliary primary 20 MHz channel of one or more other non-primary channels). In an embodiment, frame 1702 may comprise a third duration field indicating a third duration based on the second duration indicated in RTS frame 1608. STAs that receive frame 1702 may set a NAV for the second 80 MHz channel based on the second duration. The third duration may be shorter than the second duration. In an implementation, the third duration may have a later start time than the second duration. An end time of the third duration may be earlier or later or the same as an end time of the second duration. The STAs may thus refrain from accessing the second 80 MHz channel for the third duration. In an embodiment, the third duration may correspond to a remaining duration of the second duration. The AP may thus communicate with STA2 over the third and fourth 80 MHz channels without another STA attempting to communicate with the AP over the second 80 MHz channel.

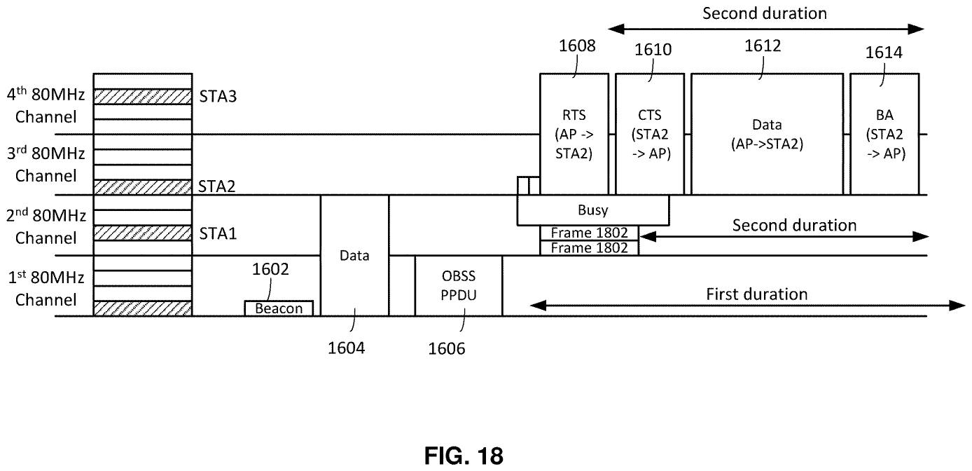

In another implementation, the AP may transmit frame 1702 on the auxiliary primary 20 MHz channel and on any idle secondary 20 MHz channels of the second 80 MHz channel (and optionally of other idle non-primary channels). For example, as shown in FIG. 18, the AP may transmit a frame 1802 (similar to frame 1702 described above) on both the auxiliary primary 20 MHz channel and an adjacent secondary 20 MHz channels of the second 80 MHz channel. In the example of FIG. 18, the other secondary 20 MHz channels of the second 80 MHz channel being idle, the AP may transmit frame 1802 on those channels. In an implementation, the AP may use a non-HT dup PPDU transmission to transmit frame 1802 on the auxiliary primary 20 MHz channel and the adjacent secondary 20 MHz channels of the second 80 MHz channel.

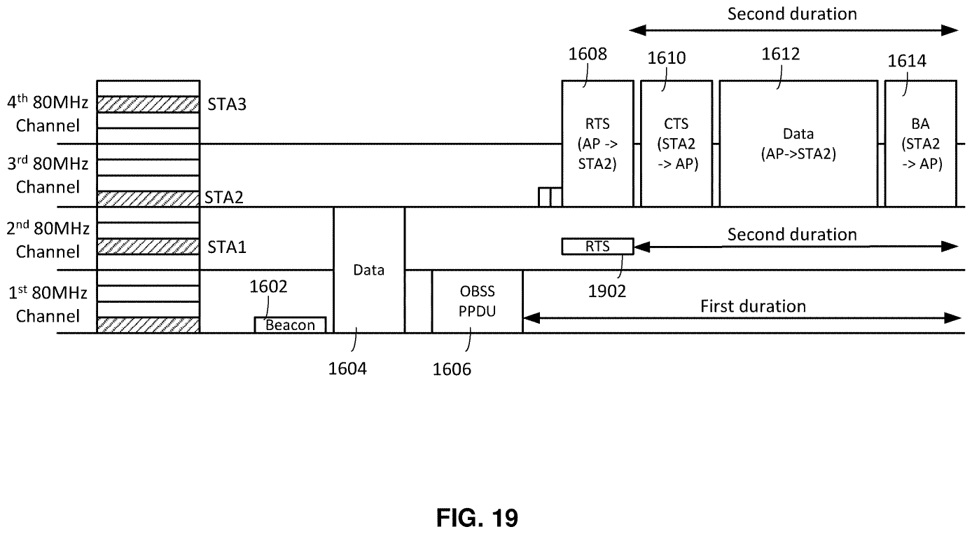

In another implementation, rather than transmitting frame 1702 on the idle non-primary channels, the AP may transmit RTS frame 1608 on those channels. That is, the AP may transmit RTS frame 1608 on all idle non-primary channels even though the AP does not intend to transmit data frame 1612 on those channels. For example, as shown in FIG. 19, the AP may transmit an RTS frame 1902 identical to RTS frame 1608 on the auxiliary primary 20 MHz channel of the second 80 MHz channel. Like RTS frame 1608, RTS frame 1902 may comprise a duration field indicating the second duration indicated in RTS frame 1608.

According to the existing IEEE 802.11 standard, a STA that used information from an RTS frame or an MU-RTS Trigger frame as the most recent basis to update its NAV setting is permitted to reset (set to zero) its NAV if no PHY-RXEARLYSIG.indication or PHYRXSTART.indication primitive is received from the PHY during a NAVTimeout period starting from when the MAC receives a PHY-RXEND.indication primitive corresponding to the detection of the RTS frame or MU-RTS Trigger frame. For example, the NAVTimeout period may be equal to (2×aSIFSTime)+(CTS_Time)+aRxPHYStartDelay+(2×aSlotTime). That is, the STA may reset its NAV set based on an RTS or MU-RTS Trigger frame if that STA does not receive, within a NAVTimeout period, the data frame for which the RTS frame is transmitted. In an implementation applicable to any of FIGS. 17-19, the same NAV resetting rules may be applied to frame 1702 (or frame 1802 or 1902) as those of RTS frame 1608. In an implementation, a STA that receives frame 1702 (or frame 1802 or 1902) on a non-primary channel and that sets its NAV for the non-primary channel based on frame 1702 (or frame 1802 or frame 1902) may reset its NAV for the non-primary channel in the same manner as for an RTS frame. In an implementation, however, when the STA resets its NAV for the non-primary channel, the STA may not be permitted to transmit to the AP on the non-primary channel immediately upon resetting its NAV. Rather, the STA may be configured to wait until the end of the NAV (as initially set based on frame 1702) before it may transmit to the AP on the non-primary channel, unless the STA is responding to a frame from the AP on the non-primary channel. The STA however may be permitted to transmit to a peer STA e.g., using EDCA, on the non-primary channel immediately upon resetting its NAV for the non-primary channel.

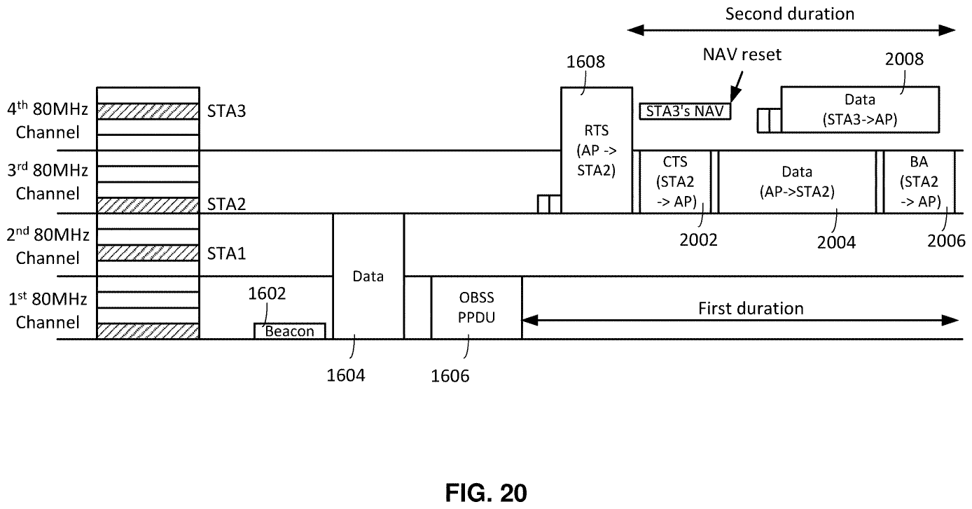

In a similar scenario, according to existing NAV reset rules, a STA may reset its NAV for a non-primary channel based on a TXOP initiating frame (e.g., RTS or MU-RTS Trigger frame) transmitted by the AP. For example, as illustrated in FIG. 20, the AP may obtain a TXOP on the auxiliary primary 20 MHz channel of the third 80 MHz channel and may transmit RTS (or an MU-RTS) frame 1608 to STA2 camped on the third 80 MHz channel. RTS frame 1608 may comprise a second duration field indicating a second duration. The second duration comprises a time period for transmission and reception of one or more frames by the AP on the third 80 MHz channel. The second duration may be within the first duration. STA2 may respond to RTS frame 1608 from the AP by transmitting a CTS frame 2002 to the AP. In response, the AP may transmit a data frame 2004 to STA2, and STA2 may acknowledge data frame 2004 by transmitting a BA frame 2006 to the AP.

In an example, STA2 may be a 160 MHz operating STA. The AP may thus use a non-HT dup PPDU transmission to transmit RTS frame 1608 to STA2 over both the third and fourth 80 MHz channels. STA3, camped on the fourth 80 MHz channel, may receive RTS frame 1608 over the fourth 80 MHz channel and may set its NAV for the fourth 80 MHz channel based on the second duration indicated in RTS frame 1608.

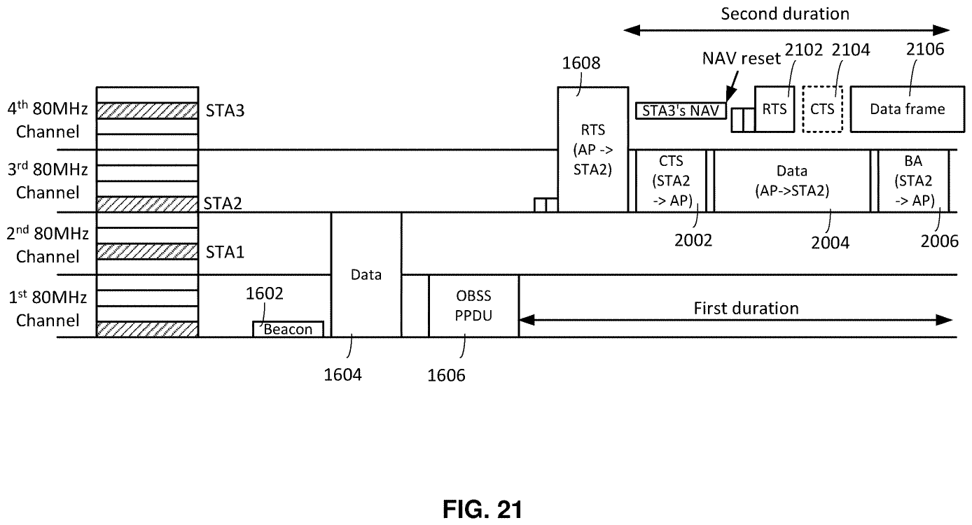

In an example, rather than also transmitting CTS frame 2002 on both the third and fourth 80 MHz channels, STA2 may transmit CTS frame 2002 on only the third 80 MHz channel. As CTS frame 2002 is transmitted on only the third 80 MHz channels, both data frame 2004 and BA frame 2006 are also transmitted over only the third 80 MHz channel. With CTS frame 2002 and data frame 2004 not transmitted over the fourth 80 MHz channel, STA3 may reset its NAV for the fourth 80 MHz channel (set based on RTS frame 1608) in accordance with existing NAV reset rules described above. In an example, as shown in FIG. 20, while the AP transmits data frame 2004 to STA2, STA3 may obtain a TXOP on the auxiliary primary channel of the fourth 80 MHz channel and may begin transmitting a data frame 2008 to the AP. However, as the AP is transmitting to STA2 over the third 80 MHz channel, the AP may fail to receive data frame 2008 from STA3 over the fourth 80 MHz channel. This may lead to resources being wasted and to increased latency in delivering the data from STA3 to the AP. Further embodiments of the present disclosure, described with reference to FIGS. 21-23 below, may be used to address this potential problem.

FIG. 21 illustrates an example of an SST-based operation according to an embodiment. As described above with respect to FIG. 20, it is also assumed in the example operation of FIG. 21 that STA2 may respond to RTS frame 1608, transmitted by the AP using DUP mode on both the third and the fourth 80 MHz channel, by transmitting CTS frame 2002 on only the third 80 MHz channel to the AP. This permits STA3, camped on the fourth 80 MHz channel, to reset its NAV for the fourth 80 MHz channel (set based on RTS frame 1608).

In an embodiment, to prevent the occurrence of the problem described in FIG. 20, a STA operating on a non-primary channel and that resets its NAV for the non-primary channel (e.g., based on existing NAV reset rules) may be configured to transmit a first frame to the AP, on the non-primary channel, before transmitting any data frame to the AP. In an implementation, the NAV that is reset by the STA is a NAV set based on a frame transmitted by the AP, or another STA of the same BSS as the STA, on the non-primary channel. The first frame may be an RTS frame or another frame of short duration. The STA may transmit the first frame on the auxiliary primary 20 MHz channel and one or more secondary 20 MHz channels of the non-primary channel. The STA may use EDCA to transmit the first frame.

In response to the first frame, the AP may be configured to transmit a second frame to the STA on the non-primary channel. The second frame may authorize or deny the STA to transmit one or more data frames to the AP on the non-primary channel, after the second frame. The second frame may be a CTS frame or another frame of short duration (e.g., Ack). The AP may transmit the second frame on the auxiliary primary 20 MHz channel and one or more secondary 20 MHz channels of the non-primary channel. In an implementation, the AP may transmit the second frame on the same 20 MHz channels of the non-primary channel on which the AP receives the first frame. The STA may transmit one or more data frames to the AP on the non-primary channel after the second frame, when the second frame authorizes the STA for the transmission. The STA may transmit the one or more data frames on the auxiliary primary 20 MHz channel and one or more secondary 20 MHz channels of the non-primary channel. In an implementation, the STA may transmit the one or more data frames on the same 20 MHz channels of the non-primary channel on which the STA transmits the first frame.

In another embodiment, the AP may be configured to transmit the second frame only to authorize the STA to transmit one or more data frames on the non-primary channel. The AP may not respond to the first frame when the AP does not wish to authorize the STA to transmit one or more data frames on the non-primary channel. The STA may transmit one or more data frames to the AP on the non-primary channel in response to receiving the second frame from the AP. The STA may not transmit any data frame to the AP on the non-primary channel when the STA does not receive the second frame from the AP.

In an embodiment, the STA may be permitted to transmit a frame to a peer STA (i.e., another non-AP STA) when the AP does not authorize (explicitly or implicitly) the STA to transmit one or more data frames to the AP on the non-primary channel. The frame transmitted to the peer STA may be a data frame or a control frame. The STA may transmit the frame to the peer STA on the auxiliary primary channel and one or more secondary channels of the non-primary channel. The STA may transmit the frame to the peer STA using EDCA.

In the example of FIG. 21, after resetting its NAV for the fourth 80 MHz channel (set based on RTS frame 1608), STA3 may transmit an RTS frame 2102 to the AP on the fourth 80 MHz channel. In an example, the AP may transmit a CTS frame 2104 authorizing STA3 to transmit one or more data frames to the AP on the fourth 80 MHz channel. On receiving CTS frame 2104, STA3 may transmit a data frame 2106 to the AP. In another example, CTS frame 2104 may deny STA3 from transmitting one or more data frames to the AP on the non-primary channel or may not be transmitted by the AP in response to RTS frame 2102. As such, STA3 may transmit data frame 2106 to a peer STA or may remain idle on the fourth 80 MHz channel.

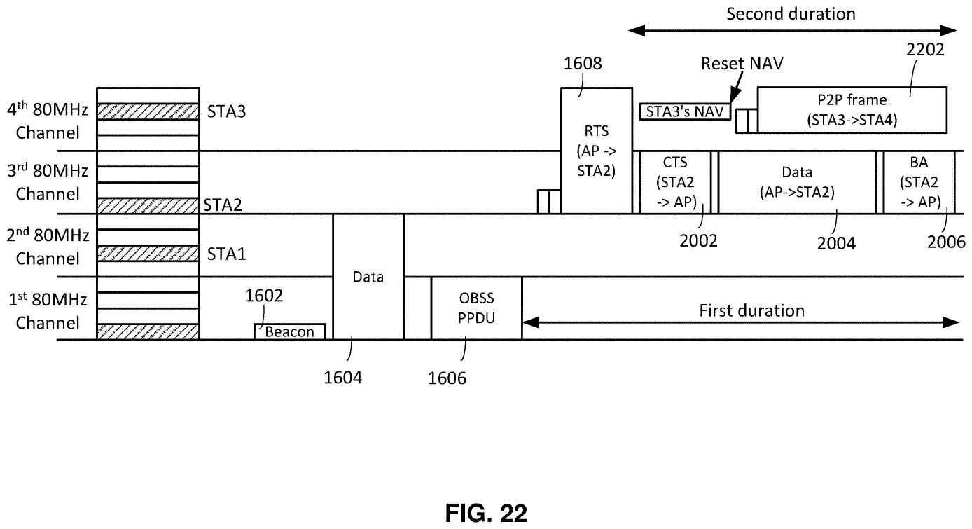

In another embodiment, illustrated in FIG. 22, a STA operating on a non-primary channel and that resets its NAV for the non-primary channel (e.g., based on existing NAV reset rules) may be permitted to transmit a frame (only) to a peer STA on the non-primary channel. In an implementation, the NAV that is reset by the STA is a NAV set based on a frame transmitted by the AP, or another STA of the same BSS as the STA, on the non-primary channel. As such, the STA may not request authorization from the AP before transmitting on the non-primary channel. The STA may transmit the frame to the peer STA on the auxiliary primary 20 MHz channel and one or more secondary 20 MHz channels of the non-primary channel. The STA may transmit the frame to the peer STA using EDCA. In the example of FIG. 22, after resetting its NAV for the fourth 80 MHz channel (set based on RTS frame 1608), STA3 may transmit a frame 2202 to STA4 on the fourth 80 MHz channel. STA3 does not request authorization from the AP to transmit frame 2202 to STA4.

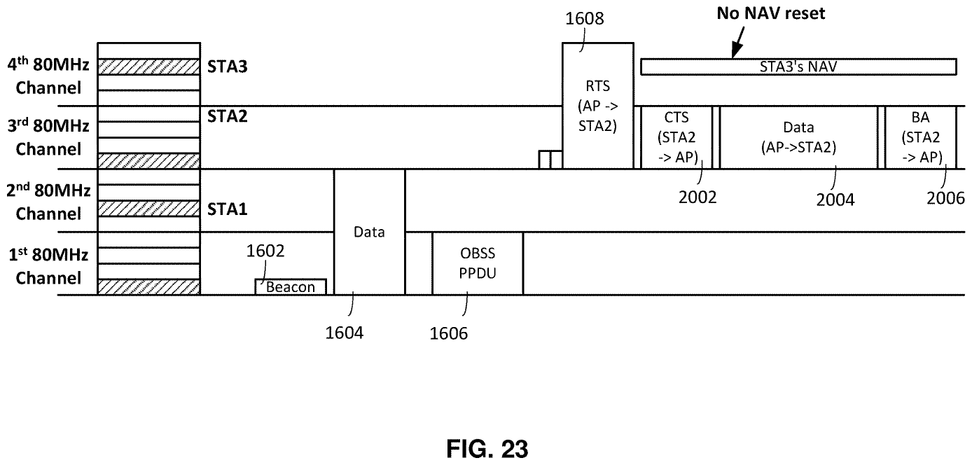

In a further embodiment, illustrated in FIG. 23, a STA operating on a non-primary channel may be configured to not reset its NAV for the non-primary channel, e.g., based on existing NAV reset rules. In an implementation, the NAV that is not reset by the STA is a NAV set based on a frame transmitted by the AP, or another STA of the same BSS as the STA, on the non-primary channel. That is, the STA may maintain its non-zero NAV for the non-primary channel even when a NAV resetting condition applies. In the example of FIG. 23, STA3, camped on the fourth 80 MHz channel, may be permitted to reset its NAV for the fourth 80 MHz channel (set based on RTS frame 1608) according to existing NAV reset rules. Nonetheless, in an embodiment, STA3 may be configured to not reset its NAV in a situation such as illustrated in FIG. 23. STA3 may thus not access the fourth 80 MHz channel while the AP transmits data frame 2004 to STA2. The above-described problem may thus be mitigated.

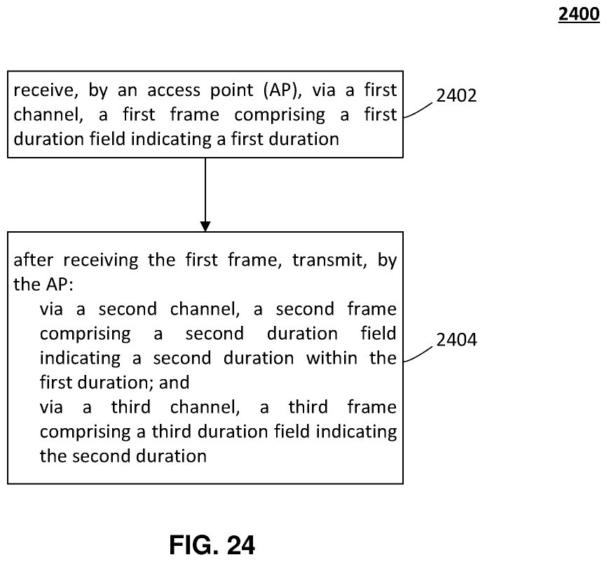

FIG. 24 illustrates an example process 2400 according to an embodiment. Example process 2400 may be performed by an AP. The AP may operate over a plurality of channels, including a primary channel and a plurality of non-primary (or auxiliary primary) channels. Each of the plurality of channels may include a plurality of 20 MHz channels, including a primary/auxiliary primary 20 MHz channel and one or more secondary 20 MHz channels. The AP may have one or more associated STAs. The AP may be an SST AP. One or more the STAs associated with the AP may be SST STAs. As shown in FIG. 24, process 2400 may include steps 2402 and 2404.

Step 2402 includes receiving, by the AP, via a first channel, a first frame comprising a first duration field indicating a first duration. The first channel may be a primary channel of the AP. The primary channel may comprise a primary 20 MHz channel. The primary may further comprise one or more secondary 20 MHz channels. The primary 20 MHz channel may be adjacent to the one or more secondary 20 MHz channels.

In an embodiment, receiving the first frame in step 2402 comprises receiving the first frame from an OBSS STA or an OBSS AP. In an embodiment the first duration comprises a time period for transmission and reception of one or more frames by the OBSS STA or OBSS AP on the first channel after the first frame. In an embodiment, the first duration field may be a TXOP duration or a NAV field of the first frame.

In an embodiment the first frame comprises an address field which value does not match a BSSID corresponding to a BSS of the AP. In an embodiment, the first frame is carried in a PPDU comprising a BSS color field. The BSS color field may indicate the OBSS.

Step 2404 includes, after receiving the first frame, transmitting, by the AP, via a second channel, a second frame comprising a second duration field indicating a second duration within the first duration; and via a third channel, a third frame comprising a third duration field indicating a third duration based on the second duration.

In an embodiment, transmission of the third frame via the third channel may be concurrent with transmission of the second frame via the second channel.

In an embodiment, transmitting the third frame comprises transmitting the third frame on the auxiliary primary 20 MHz channel and, optionally, on any idle secondary 20 MHz channel of the third channel. In another embodiment, step 2404 may further comprise transmitting the third frame on any other idle non-primary channels (other than the second and third channels).

The second channel and the third channel may be primary channels auxiliary to the first channel or non-primary channels. The second channel and/or third channel may comprise an auxiliary primary 20 MHz channel. The auxiliary primary 20 MHz channel may comprise a primary 20 MHz channel auxiliary to the first channel. The second channel and/or the third channel may comprise one or more secondary 20 MHz channels. The auxiliary primary 20 MHz channel may be adjacent to the one or more secondary 20 MHz channels.

In an embodiment, the second duration comprises a time period for transmission and reception of one or more frames by the AP or STA associated with the AP on the second channel after the second frame. In an embodiment, the second duration field may be a TXOP duration or a NAV field of the second frame.

In an embodiment, the second duration is based on the first duration. In an embodiment, the second duration is shorter than the first duration. In an embodiment, a start time of the second duration is later than a start time of the first duration. In an embodiment, an end time of the second duration is same as an end time of the first duration. In another embodiment, an end time of the first duration is later than an end time of the second duration.

In an embodiment, the third frame reserves the third channel for the third duration. wherein the third duration is shorter than the second duration.

The third duration may be shorter than the second duration. In an embodiment, the third duration corresponds to a remaining duration of the second duration.

In an embodiment, a start time of the third duration is later than a start time of the second duration. An end time of the third duration may be earlier, later, or the same as the end time of the second duration.

In embodiments, the first frame, the second frame, and/or the third frame may be a control frame, a management frame, an action frame, or a QoS data/null frame.

In an embodiment, the third frame may be an RTS frame, a CTS-to-self frame, or an NDP frame. In another embodiment, the third frame may be identical to the second frame.

In an embodiment, process 2400 may further comprise transmitting, by the AP, a fourth frame comprising a medium synchronization duration for the second channel. The fourth frame may be a beacon frame, a probe response frame, an association frame, or a fast initial link setup (FILS) frame. In another embodiment, process 2400 may further comprise transmitting, by the AP, the second frame during the medium synchronization duration. In an embodiment, the second frame may aid a STA associated with the AP to acquire medium synchronization on the second channel.

In an embodiment, process 2400 may further comprise transmitting/receiving, by the AP to/from a STA via the second channel, one or more frames during the second duration.

In an embodiment, process 2400 may further comprise transmitting, by the AP, a fifth frame indicating support of full CCA capability on the first channel and the second channel. In another embodiment, the fifth frame may, additionally or alternatively, indicate support of capability to switch to the second channel on the condition of detecting the first frame indicating an inter-BSS (or OBSS) PPDU. In an embodiment, the fifth frame may be a probe response frame, an association response frame, a beacon frame, or a FILS discovery frame.

In an embodiment, process 2400 may further comprise receiving, by the AP from a STA, a sixth frame indicating support for contention-based transmission on the second channel; and transmitting, by the AP to the STA, the fifth frame in response to the sixth frame.

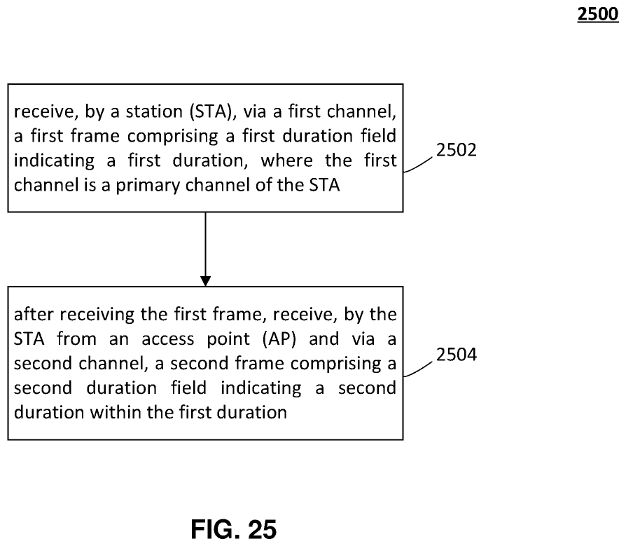

FIG. 25 illustrates another example process 2500 according to an embodiment. Example process 2500 may be performed by a STA. The STA may operate over a plurality of channels, including a primary channel and a plurality of non-primary (or auxiliary primary) channels. Each of the plurality of channels may include a plurality of 20 MHz channels, including a primary/auxiliary primary 20 MHz channel and one or more secondary 20 MHz channels. The STA may be an SST STA. The STA may be associated with an AP. The AP may be an SST AP. As shown in FIG. 25, process 2500 may include steps 2502 and 2504.

Step 2502 includes receiving, by the STA, via a first channel, a first frame comprising a first duration field indicating a first duration. The first channel may be a primary channel of the AP. The primary channel may comprise a primary 20 MHz channel. The primary channel may further comprise one or more secondary 20 MHz channels. The primary 20 MHz channel may be adjacent to the one or more secondary 20 MHz channels.

In an embodiment, receiving the first frame in step 2502 comprises receiving the first frame from an OBSS STA or an OBSS AP. In an embodiment the first duration comprises a time period for transmission and reception of one or more frames by the OBSS STA or OBSS AP on the first channel after the first frame. In an embodiment, the first duration field may be a TXOP duration or a NAV field of the first frame.

In an embodiment the first frame comprises an address field which value does not match a BSSID corresponding to a BSS of the STA. In an embodiment, the first frame is carried in a PPDU comprising a BSS color field. The BSS color field may indicate the OBSS.

Step 2502 includes, after receiving the first frame, receiving, by the STA from the AP and via a second channel, a second frame comprising a second duration field indicating a second duration within the first duration.

The second channel may be a primary channel auxiliary to the first channel or a non-primary channel. The second channel may comprise an auxiliary primary 20 MHz channel. The auxiliary primary 20 MHz channel may comprise a primary 20 MHz channel auxiliary to the first channel. The second channel may comprise one or more secondary 20 MHz channels. The auxiliary primary 20 MHz channel may be adjacent to the one or more secondary 20 MHz channels.

In an embodiment, the second duration comprises a time period for transmission and reception of one or more frames by the AP or the STA on the second channel after the second frame. In an embodiment, the second duration field may be a TXOP duration or a NAV field of the second frame.

In an embodiment, the second duration is based on the first duration. In an embodiment, the second duration is shorter than the first duration. In an embodiment, a start time of the second duration is later than a start time of the first duration. In an embodiment, an end time of the second duration is same as an end time of the first duration. In another embodiment, an end time of the first duration is later than an end time of the second duration.

In embodiments, the first frame, the second frame, and/or the third frame may be a control frame, a management frame, an action frame, or a QoS data/null frame.

In an embodiment, process 2500 may further comprise receiving, by the STA from the AP, a third frame comprising a medium synchronization duration for the second channel. The third frame may be a beacon frame, a probe response frame, an association frame, or a fast initial link setup (FILS) frame. In another embodiment, process 2500 may further comprise receiving, by the STA, the second frame during the medium synchronization duration. In an embodiment, the second frame may aid the STA to acquire medium synchronization on the second channel.

In an embodiment, process 2500 may further comprise transmitting/receiving, by the STA to/from the AP via the second channel, one or more frames during the second duration.

In an embodiment, process 2500 may further comprise receiving, by the STA from the AP, a fourth frame indicating support of full CCA capability on the first channel and the second channel. In another embodiment, the fourth frame may, additionally or alternatively, indicate support of capability to switch to the second channel on the condition of detecting the first frame indicating an inter-BSS (or OBSS) PPDU. In an embodiment, the fourth frame may be a probe response frame, an association response frame, a beacon frame, or a FILS discovery frame.

In an embodiment, process 2500 may further comprise transmitting, by the STA to the AP, a fifth frame indicating support for contention-based transmission on the second channel; and receiving, by the STA from the AP, the fourth frame in response to the fifth frame.

1. An access point (AP) comprising:
one or more processors; and
memory storing instructions that, when executed by the one or more processors, cause the AP to:
receive, via a first channel, a first frame comprising a first duration field indicating a first duration; and
after receiving the first frame, transmit:
via a second channel, a second frame comprising a second duration field indicating a second duration within the first duration; and
via a third channel, a third frame comprising a third duration field indicating a third duration based on the second duration.

2. The AP of claim 1, wherein the first channel is a primary channel of the AP.

3. The AP of claim 2, wherein the primary channel comprises one or more secondary 20 MHz channels.

4. The AP of claim 1, wherein the second channel and the third channel are primary channels auxiliary to the first channel.

5. The AP of claim 1, wherein the second channel comprises an auxiliary primary 20 MHz channel.

6. The AP of claim 1, wherein the third channel comprises an auxiliary primary 20 MHz channel.

7. The AP of claim 1, wherein receiving the first frame comprises receiving the first frame from an overlapping basic service set (OBSS) station (STA) or an OBSS AP.

8. The AP of claim 1, wherein the second duration comprises a time period for transmission and reception of one or more frames by the AP or a station (STA) associated with the AP on the second channel after the second frame.

9. The AP of claim 1, wherein the first frame, the second frame, or the third frame is a control frame, a management frame, an action frame, or a quality of service (QoS) data/null frame.

10. A station (STA) comprising:
one or more processors; and
memory storing instructions that, when executed by the one or more processors, cause the STA to:
receive, via a first channel, a first frame comprising a first duration field indicating a first duration, wherein the first channel is a primary channel of the STA; and
after receiving the first frame, receive, from an access point (AP) and via a second channel, a second frame comprising a second duration field indicating a second duration within the first duration.

11. The STA of claim 10, wherein the primary channel comprises one or more secondary 20 MHz channels.

12. The STA of claim 10, wherein the second channel is a primary channel auxiliary to the first channel.

13. The STA of claim 12, wherein the second channel comprises an auxiliary primary 20 MHz channel.

14. The STA of claim 10, wherein receiving the first frame comprises receiving the first frame from an overlapping basic service set (OBSS) station (STA) or an OBSS AP.

15. The STA of claim 14, wherein the first duration comprises a time period for transmission and reception of one or more frames by the OBSS STA or OBSS AP on the first channel after the first frame.

16. The STA of claim 15, wherein the second duration comprises a time period for transmission and reception of one or more frames by the AP or the STA on the second channel after the second frame.

17. The STA of claim 10, wherein the first frame or the second frame is a control frame, a management frame, an action frame, or a quality of service (QoS) data/null frame.

18. A non-transitory computer-readable medium comprising instructions that, when executed by one or more processors of an access point (AP), cause the AP to:
receive, via a first channel, a first frame comprising a first duration field indicating a first duration; and
after receiving the first frame, transmit:
via a second channel, a second frame comprising a second duration field indicating a second duration within the first duration; and
via a third channel, a third frame comprising a third duration field indicating a third duration based on the second duration.

19. The non-transitory computer-readable medium of claim 18, wherein the second channel and the third channel are primary channels auxiliary to the first channel.

20. The non-transitory computer-readable medium of claim 18, wherein receiving the first frame comprises receiving the first frame from an overlapping basic service set (OBSS) station (STA) or an OBSS AP.
